(19) United States
(12) Patent Application Publication
(10) Pub. No.: US 2016/0207283 A1
(43) Pub. Date: Jul. 21, 2016

(54) COMPOSITE ARTICLES INCLUDING FILMS WITH A TIE LAYER

(71) Applicants: Ruomiao Wang, Forest, VA (US); Bruno Taber, Munsingen (CH); Olaf Meincke, Bern (CH)

(72) Inventors: Ruomiao Wang, Forest, VA (US); Bruno Taber, Munsingen (CH); Olaf Meincke, Bern (CH)

(21) Appl. No.: 14/925,074

(22) Filed: Oct. 28, 2015

Related U.S. Application Data
(60) Provisional application No. 62/072,261, filed on Oct. 29, 2014.
(60) Provisional application No. 62/169,412, filed on Jun. 1, 2015.

(51) Int. Cl. B32B 7/12; B32B 27/40; B32B 27/20; B32B 27/32; B32B 5/02; B32B 27/08

(52) U.S. Cl. CPC B32B 7/12; B32B 5/02; B32B 27/08; B32B 27/20; B32B 27/32; B32B 27/40; B32B 2262/101; B32B 2419/00; B32B 2605/00

(57) ABSTRACT

Certain embodiments described herein are directed to composite articles comprising a core layer and a film comprising a high viscosity thermoplastic layer and a tie layer. The articles can be used in automotive and/or aerospace applications to provide lightweight interior components such as a headliner, sidewall or other structural components. Cover layers and other layers can also be present on the articles to provide additional functionality or for aesthetic purposes.

### PRIORITY APPLICATIONS

This application claims priority to, and the benefit of, U.S. Provisional Application No. 62/072,261 filed on Oct. 29, 2014 and to U.S. Provisional Application No. 62/169,412 filed on Jun. 1, 2015, the entire disclosure of each of which is hereby incorporated herein by reference.

### TECHNOLOGICAL FIELD

This application is related to composite articles that include one or more films with an integral tie layer. In certain configurations, composite articles that include a thermoplastic core and a film with integral tie layer disposed on the thermoplastic core are described.

### BACKGROUND

Articles for automotive and construction materials applications typically are designed to meet a number of competing and stringent performance specifications. In automotive applications such as headliners, decorative foam-type cover materials are widely used. The open nature of the foam presents adhesive challenges, and the substrate to which the material must attach may be porous as well.

### SUMMARY

In one aspect, a composite material comprising a permeable core layer comprising a thermoplastic material and a plurality of reinforcing fibers, a film disposed on the core layer, the film comprising a thermoplastic layer and a tie layer, in which a viscosity of thermoplastic material in the thermoplastic layer is greater than a viscosity of materials of the tie layer, and a cover layer disposed on the film, in which the tie layer of the film is effective to increase adhesion between the cover layer and the film compared to a film lacking the tie layer is provided.

In certain embodiments, the thermoplastic layer comprises a polyolefin material. In other embodiments, the thermoplastic layer comprises a first layer and a second layer. In some configurations, at least one of the first layer and the second layer comprises a polypropylene. In additional configurations, the first layer comprises a first polypropylene comprising a first melt flow index and the second layer comprises a second polypropylene comprising a second melt flow index, in which the first melt flow index is lower than the second melt flow index. In further instances, the tie layer is present between the first layer and the second layer. In some embodiments, the film comprises a basis weight of less than 80 gsm, less than 70 gsm or less than 60 gsm. In other embodiments, the film comprises at five layers, e.g., a 5-layer film comprises a polyamide or copolyamide optionally without any caprolactam. In some instances, the film comprises a first layer comprising a polypropylene, a second layer disposed on the first layer, the second layer comprising the tie layer, a third layer disposed on the second layer and comprising a polypropylene, a fourth layer disposed on the third layer and comprising an additional tie layer, and a fifth layer disposed on the fourth layer and comprising the polyamide or copolyamide. In other configurations, the film comprises a basis weight of less than 80 gsm, less than 70 gsm, or less than 60 gsm. In some embodiments, each of the five layers is present at about the same thickness. In additional embodiments, the polypropylene of the third layer comprises a viscosity greater than a viscosity of polypropylene of the first layer. In certain instances, a viscosity of the polypropylene of the third layer is about 50% higher than a viscosity of polypropylene in the first layer. In other embodiments, the tie layer and the additional tie layer comprise at least one common material. In further instances, the film comprises a bilayer comprising a first layer effective to provide adherence and a second non-polar layer coupled to the first layer. In other embodiments, the cover layer comprises one or more of a polyurethane, a non-woven material, a woven material, a fabric and a film. In some instances, the composite material comprises an additional layer disposed between the film and the cover layer. In other embodiments, the core layer comprises polypropylene and glass fibers. In certain examples, the thermoplastic material is present at about 20 weight percent to about 80 weight percent based on the weight of the core layer. In other examples, the glass fibers are present at about 30 weight percent to about 70 weight percent based on the weight of the core layer.

In another aspect, a composite material comprising permeable core layer comprising a thermoplastic material and a plurality of reinforcing fibers, a film disposed on the core layer, the film comprising a thermoplastic layer, a tie layer and an adhesive layer, in which a viscosity of thermoplastic material in the thermoplastic layer is greater than a viscosity of materials in the tie layer and the adhesive layer, and a cover layer disposed on the film, in which the adhesive layer is effective to increase adhesion between the cover layer and the thermoplastic core layer compared to a film lacking the adhesive layer is disclosed.

In certain configurations, adhesion of the film is substantially the same as adhesion of a comparative film lacking the tie layer and comprising a basis weight of at least 10% greater than the film. In other instances, the adhesive layer is present at about 30 gsm or less. In some embodiments, the cover layer comprises a polyurethane, a non-woven material, a woven material, a fabric and a film. In other embodiments, the film is configured as a 5-layer film, e.g., a 5-layer film where one of the five layers comprises a polyamide or copolyamide optionally without any caprolactam. In some instances, the adhesive layer is present as an outer layer of the film and comprises a polyamide or copolyamide optionally without any caprolactam, in which the adhesive layer is disposed on the tie layer, in which the tie layer is disposed on the thermoplastic layer, in which the thermoplastic layer is disposed on an additional tie layer, and in which the additional tie layer is disposed on an additional thermoplastic layer. In other instances, the thermoplastic layer and the additional thermoplastic layer comprise at least one common material. In further embodiments, the thermoplastic layer and the additional thermoplastic layer each comprise a polyolefin, in which a viscosity of the polyolefin in the thermoplastic layer is greater than a viscosity of the polyolefin in the additional thermoplastic layer. In additional embodiments, the core layer comprises polypropylene and glass fibers. In other embodiments, the thermoplastic layer comprises polypropylene, the adhesive layer comprises a polyamide or copolyamide optionally without any caprolactam and the tie layer comprises a thermoplastic material.

In an additional aspect, a composite article comprising a first permeable core layer comprising a thermoplastic material and a plurality of reinforcing fibers, a second permeable core layer comprising a thermoplastic material and a plurality of reinforcing fibers, a film comprising a thermoplastic layer, an adhesive layer and a tie layer between the thermoplastic layer and the adhesive layer, in which a viscosity of thermoplastic material in the thermoplastic layer is greater than a viscosity of materials of the adhesive layer and the tie layer, in which the film is positioned between the first permeable core layer and the second permeable core layer to couple the first permeable core layer to the second permeable core layer is provided.

In certain embodiments, the film is configured as a 5-layer film, e.g., a film with one of the five layers comprising a polyamide or copolyamide optionally without any caprolactam. In other instances, the adhesive layer is present as an outer layer of the film (e.g., the outer layer comprises a polyamide or copolyamide optionally without any caprolactam), in which the adhesive layer is disposed on the tie layer, in which the tie layer is disposed on the thermoplastic layer, in which the thermoplastic layer is disposed on an additional tie layer, and in which the additional tie layer is disposed on an additional thermoplastic layer. In certain embodiments, the thermoplastic layer comprises a polyolefin material. In some examples, the thermoplastic layer comprises a first layer and a second layer. In certain embodiments, at least one of the first layer and the second layer comprises a polypropylene. In some examples, the first layer comprises a first polypropylene comprising a first melt flow index and the second layer comprises a second polypropylene comprising a second melt flow index, in which the first melt flow index is lower than the second melt flow index. In other examples, the tie layer is present between the first layer and the second layer. In some embodiments, the film comprises a basis weight of less than 80 gsm, less than 70 gsm or less than 60 gsm. In certain examples, the film comprises a bilayer comprising a first layer effective to provide adherence and a second non-polar layer coupled to the first layer.

In another aspect, a composite material comprises a permeable core layer comprising a thermoplastic material and a plurality of reinforcing fibers, a film disposed on the core layer, the film comprising a thermoplastic layer and a tie layer, in which a viscosity of thermoplastic material in the thermoplastic layer is greater than a viscosity of materials of the tie layer, wherein the film comprises three or more layers, and a cover layer disposed on the film, in which the tie layer of the film is effective to increase adhesion between the cover layer and the film compared to a film lacking the tie layer.

In certain examples, the thermoplastic layer comprises a polyolefin material. In other examples, the thermoplastic layer comprises a first layer and a second layer. In further examples, at least one of the first layer and the second layer comprises a polypropylene. In additional embodiments, the first layer comprises a first polypropylene comprising a first melt flow index and the second layer comprises a second polypropylene comprising a second melt flow index, in which the first melt flow index is lower than the second melt flow index. In some instances, the tie layer is present between the first layer and the second layer. In other examples, the film comprises a basis weight of less than 80 gsm, less than 70 gsm or less than 60 gsm. In some examples, the film comprises at five layers. In certain examples, the film comprises a first layer comprising a polypropylene, a second layer disposed on the first layer, the second layer comprising the tie layer, a third layer disposed on the second layer and comprising a polypropylene, a fourth layer disposed on the third layer and comprising an additional tie layer, and a fifth layer disposed on the fourth layer and comprising a polyamide or copolyamide optionally without any caprolactam. In some embodiments, the film comprises a basis weight of less than 80 gsm, less than 70 gsm or less than 60 gsm. In other instances, each of the five layers is present at about the same thickness. In further examples, the polypropylene of the third layer comprises a viscosity greater than a viscosity of polypropylene of the first layer. In other instances, a viscosity of the polypropylene of the third layer is about 50% higher than a viscosity of polypropylene in the first layer. In certain configurations, the tie layer and the additional tie layer comprise at least one common material. In some embodiments, the film comprises a first layer effective to provide adherence and a second non-polar layer coupled to the first layer. In other examples, the cover layer comprises one or more of a polyurethane, a non-woven material, a woven material, a fabric and a film. In some embodiments, the material further comprises an additional layer disposed between the film and the cover layer. In some examples, the core layer comprises polypropylene and glass fibers. In other examples, the thermoplastic material is present at about 20 weight percent to about 80 weight percent based on the weight of the core layer. In further examples, the glass fibers are present at about 30 weight percent to about 70 weight percent based on the weight of the core layer.

In an additional aspect, a composite material comprises a permeable core layer comprising a thermoplastic material and a plurality of reinforcing fibers, a film disposed on the core layer, the film comprising a thermoplastic layer, a tie layer and an adhesive layer, in which a viscosity of thermoplastic material in the thermoplastic layer is greater than a viscosity of materials in the tie layer and the adhesive layer, and wherein the film comprises more than three layers, and a cover layer disposed on the film, in which the adhesive layer is effective to increase adhesion between the cover layer and the permeable core layer compared to a film lacking the adhesive layer.

In certain embodiments, adhesion of the film is substantially the same as adhesion of a comparative film lacking the tie layer and comprising a basis weight of at least 10% greater than the film. In other embodiments, the adhesive layer is present at about 30 gsm or less. In certain embodiments, the cover layer comprises a polyurethane, a non-woven material, a woven material, a fabric and a film. In other embodiments, the film is configured as a 5-layer film. In some instances, the adhesive layer is present as an outer layer of the film and comprises a polyamide or copolyamide optionally without any caprolactam, in which the adhesive layer is disposed on the tie layer, in which the tie layer is disposed on the thermoplastic layer, in which the thermoplastic layer is disposed on an additional tie layer, and in which the additional tie layer is disposed on an additional thermoplastic layer. In certain instances, the thermoplastic layer and the additional thermoplastic layer comprise at least one common material. In some embodiments, the thermoplastic layer and the additional thermoplastic layer each comprise a polyolefin, in which a viscosity of the polyolefin in the thermoplastic layer is greater than a viscosity of the polyolefin in the additional thermoplastic layer. In certain examples, the core layer comprises polypropylene and glass fibers. In some examples, the thermoplastic layer comprises polypropylene, the adhesive layer comprises a polyamide and the tie layer comprises a thermoplastic material.

In another aspect, a composite article comprises a first permeable core layer comprising a thermoplastic material and a plurality of reinforcing fibers, a second permeable core layer comprising a thermoplastic material and a plurality of reinforcing fibers, a film disposed on the core layer, the film comprising a thermoplastic layer, an adhesive layer and a tie layer between the thermoplastic layer and the adhesive layer, in which a viscosity of thermoplastic material in the thermoplastic layer is greater than a viscosity of materials of the adhesive layer and the tie layer, in which the film is positioned between the first permeable core layer and the second permeable core layer to couple the first permeable core layer to the second permeable core layer, and wherein the film comprises more than three layers.

In certain configurations, the film is configured as a 5-layer film. In some instances, the adhesive layer is present as an outer layer of the film and comprises a polyamide or copolyamide optionally without any caprolactam, in which the adhesive layer is disposed on the tie layer, in which the tie layer is disposed on the thermoplastic layer, in which the thermoplastic layer is disposed on an additional tie layer, and in which the additional tie layer is disposed on an additional thermoplastic layer. In other instances, the thermoplastic layer comprises a polyolefin material. In some embodiments, the thermoplastic layer comprises a first layer and a second layer. In additional embodiments, at least one of the first layer and the second layer comprises a polypropylene. In other examples, the first layer comprises a first polypropylene comprising a first melt flow index and the second layer comprises a second polypropylene comprising a second melt flow index, in which the first melt flow index is lower than the second melt flow index. In certain examples, the tie layer is present between the first layer and the second layer. In other examples, the film comprises a basis weight of less than 80 gsm, less than 70 gsm or less than 60 gsm. In some instances, the film comprises a first layer effective to provide adherence and a second non-polar layer coupled to the first layer.

In another aspect, a method of forming a composite material comprising combining a thermoplastic polymer and a plurality of reinforcing fibers in an aqueous solution, mixing the aqueous solution comprising the thermoplastic polymer and the reinforcing fibers to disperse the reinforcing fibers in the thermoplastic polymer to provide an aqueous foam dispersion, disposing the aqueous foam dispersion onto a forming element, removing liquid from the disposed aqueous foam to provide a web comprising the thermoplastic polymer and the reinforcing fibers, heating the web above a softening temperature of the thermoplastic polymer of the web, disposing a film comprising a thermoplastic layer and a tie layer on the web, in which a viscosity of thermoplastic material in the thermoplastic layer of the film is greater than a viscosity of materials of the tie layer, and disposing a cover layer on the disposed film to provide the composite material is disclosed.

In certain embodiments, the method comprises compressing the composite material to a predetermined thickness to form a composite article. In other embodiments, the method comprises configuring the thermoplastic layer of the film to comprise a first layer and a second layer. In further embodiments, the method comprises configuring the first layer to comprise a first polypropylene comprising a first melt flow index and configuring the second layer to comprise a second polypropylene comprising a second melt flow index, in which the first melt flow index is lower than the second melt flow index. In additional examples, the method comprises configuring the tie layer to be between the first layer and the second layer of the thermoplastic layer of the film. In some examples, the method comprises selecting a basis weight of the film to be less than 80 gsm, less than 70 gsm or less than 60 gsm. In certain examples, the method comprises configuring the film to comprise at five layers. In other instances, the method comprises configuring the film to comprise a first layer comprising a polypropylene, a second layer disposed on the first layer, the second layer comprising the tie layer, a third layer disposed on the second layer and comprising a polypropylene, a fourth layer disposed on the third layer and comprising an additional tie layer, and a fifth layer disposed on the fourth layer and comprising a polyamide. In certain configurations, the method comprises configuring the polypropylene of the third layer to comprise a viscosity greater than a viscosity of polypropylene of the first layer. In some examples, the method comprises configuring a viscosity of the polypropylene of the third layer to be at least 50% higher than a viscosity of polypropylene in the first layer. In other examples, the method comprises configuring the tie layer and the additional tie layer to comprise at least one common material. In some embodiments, the method comprises configuring the film as a bilayer comprising a first layer effective to provide adherence and a second non-polar layer coupled to the first layer. In certain examples, the method comprises configuring the cover layer to comprise one or more of a polyurethane, a non-woven material, a woven material, a fabric and a film. In some embodiments, the method comprises disposing an additional layer between the film and the cover layer. In certain examples, the method comprises configuring the web to comprise polypropylene as the thermoplastic material and glass fibers as the reinforcing fibers. In some instances, the method comprises configuring the thermoplastic material of the web to be present at about 20 weight percent to about 80 weight percent based on the weight of the web. In other examples, the method comprises configuring the glass fibers to be present at about 30 weight percent to about 70 weight percent based on the weight of the core layer. In certain instances, the method comprises configuring the film to comprise at least three layers with an outer layer of the film furthest from the web to comprise a polyamide or copolyamide optionally without any caprolactam. In other examples, the method comprises configuring the film to comprise at least four layers with an outer layer of the film furthest from the web to comprise a polyamide or copolyamide optionally without any caprolactam. In some examples, the method comprises configuring the film to comprise at least five layers with an outer layer of the film furthest from the web to comprise a polyamide or copolyamide optionally without any caprolactam.

In another aspect, a method of forming a composite material comprises combining a thermoplastic polymer and a plurality of reinforcing fibers in an aqueous solution, mixing the aqueous solution comprising the thermoplastic polymer and the reinforcing fibers to disperse the reinforcing fibers in the thermoplastic polymer to provide an aqueous foam dispersion, disposing the aqueous foam dispersion onto a forming element, removing liquid from the disposed aqueous foam to provide a web comprising the thermoplastic polymer and the reinforcing fibers, heating the web above a softening temperature of the thermoplastic polymer of the web, disposing a film comprising a thermoplastic layer and a tie layer on the web, in which a viscosity of thermoplastic material in the thermoplastic layer of the film is greater than a viscosity of materials of the tie layer and wherein the film comprises three or more layers, and disposing a cover layer on the disposed film to provide the composite material.

In certain embodiments, the method comprises compressing the composite material to a predetermined thickness to form a composite article. In other embodiments, the method comprises configuring the thermoplastic layer of the film to comprise a first layer and a second layer. In some instances, the method comprises configuring the first layer to comprise a first polypropylene comprising a first melt flow index and configuring the second layer to comprise a second polypropylene comprising a second melt flow index, in which the first melt flow index is lower than the second melt flow index. In further embodiments, the method comprises configuring the tie layer to be between the first layer and the second layer of the thermoplastic layer of the film. In certain examples, the method comprises selecting a basis weight of the film to be less than 80 gsm, less than 70 gsm or less than 60 gsm. In other examples, the method comprises configuring the film to comprise at five layers. In some instances, the method comprises configuring the film to comprise a first layer comprising a polypropylene, a second layer disposed on the first layer, the second layer comprising the tie layer, a third layer disposed on the second layer and comprising a polypropylene, a fourth layer disposed on the third layer and comprising an additional tie layer, and a fifth layer disposed on the fourth layer and comprising a polyamide or copolyamide optionally without any caprolactam. In some examples, the method comprises configuring the polypropylene of the third layer to comprise a viscosity greater than a viscosity of polypropylene of the first layer. In other embodiments, the method comprises configuring a viscosity of the polypropylene of the third layer to be at least 50% higher than a viscosity of polypropylene in the first layer. In further instances, the method comprises configuring the tie layer and the additional tie layer to comprise at least one common material. In some examples, the method comprises configuring the film with a first layer effective to provide adherence and a second non-polar layer coupled to the first layer. In some embodiments, the method comprises configuring the cover layer to comprise one or more of a polyurethane, a non-woven material, a woven material, a fabric and a film. In other examples, the method comprises disposing an additional layer between the film and the cover layer. In some instances, the method comprises configuring the web to comprise polypropylene as the thermoplastic material and glass fibers as the reinforcing fibers. In certain embodiments, the method comprises configuring the thermoplastic material of the web to be present at about 20 weight percent to about 80 weight percent based on the weight of the web. In other examples, the method comprises configuring the glass fibers to be present at about 30 weight percent to about 70 weight percent based on the weight of the core layer. In further examples, the method comprises configuring the film with an outer layer of the film furthest from the web to comprise a polyamide or copolyamide optionally without any caprolactam. In certain embodiments, the method comprises configuring the film to comprise at least four layers with an outer layer of the film furthest from the web to comprise a polyamide or copolyamide optionally without any caprolactam. In other examples, the method comprises configuring the film to comprise at least five layers with an outer layer of the film furthest from the web to comprise a polyamide or copolyamide optionally without any caprolactam.

Additional features, aspect, examples and embodiments are described in more detail below.

### BRIEF DESCRIPTION OF THE FIGURES

Certain embodiments are described with reference to the accompanying figures in which:

FIG. 1 is an illustration of an article comprising a core layer and a film, in accordance with certain examples;

FIG. 2 is an illustration of an article comprising a core layer, a film and a cover layer, in accordance with certain examples;

FIG. 3 is an illustration of a bilayer film, in accordance with certain configurations;

FIG. 4 is an illustration of a three layer film, in accordance with certain configurations;

FIG. 5A is an illustration of a multi-layer film, in accordance with certain configurations;

FIG. 5B is another illustration of a multi-layer film, in accordance with certain configurations;

FIG. 6A is an illustration of an article comprising two core layers with a film between them, in accordance with certain embodiments;

FIG. 6B is an illustration of an article comprising two core layers with a film between them and with an additional film disposed on a surface of one of the core layers, in accordance with certain embodiments;

FIG. 7A is an illustration of an article comprising two core layers with a film disposed on a surface of one of the core layers, in accordance with certain embodiments;

FIG. 7B is an illustration of an article comprising two core layers with a film disposed on a surface of each of the core layers, in accordance with certain embodiments;

FIG. 8 is an illustration of film strips disposed on a surface of a core layer in a longitudinal (machine) direction of the core layer, in accordance with certain configurations;

FIG. 9 is an illustration of film strips disposed on a surface of a core layer in a cross direction of the core layer, in accordance with certain configurations;

FIG. 10 is an illustration of film strips disposed in the machine and cross directions on a surface of the core layer, in accordance with certain examples;

FIG. 11 is an illustration of a plurality of film strips disposed in the machine and cross directions on a surface of the core layer, in accordance with certain examples;

FIG. 12 is a differential scanning calorimetry curve of a film comprising a high viscosity tie layer, in accordance with certain examples;

FIG. 13 is a differential scanning calorimetry curve of a film with a basis weight of 60 gsm, in accordance with certain examples;

FIG. 14 is a differential scanning calorimetry curve of a film with a basis weight of 80 gsm, in accordance with certain examples;

FIG. 15 is a bar graph showing the peel strength of articles, in accordance with certain embodiments;

FIG. 16 is a bar graph showing peel strength of composite articles under various conditions, in accordance with certain embodiments;

FIG. 17 is a table showing various settings and physical parameters for test articles, in accordance with certain embodiments;

FIG. 18 is a bar graph showing peel strength of articles in the machine direction under different conditions, in accordance with certain embodiments;

FIG. 19 is a bar graph showing peel strength of articles in the cross direction under different conditions, in accordance with certain embodiments;

FIG. 20 is a bar graph showing the peel strength of various articles under three different conditions, in accordance with certain examples;

FIG. 21 is a bar graph showing the peel strength of other articles under three different conditions, in accordance with certain examples;

FIG. 22 is a bar graph showing the peel strength of additional articles under three different conditions, in accordance with certain examples;

FIG. 23 is a bar graph showing the peel strength of certain articles under three different conditions, in accordance with certain examples;

FIGS. 24 and 25 show acoustic absorption of different comprise articles, in accordance with certain configurations;

FIGS. 26A and 26B show peel strength for various articles including a 3.5 mm thick core, in accordance with certain examples;

FIGS. 27A and 27B show peel strength for various articles including a 3.0 mm thick core, in accordance with certain examples;

FIG. 28 includes a table showing the various test conditions used for the graphs of FIGS. 26A-27B;

FIG. 29 is a graph showing the peel strength for various headline plaques, in accordance with certain examples;

FIG. 30 is a table showing the testing conditions used in the graph of FIG. 29;

FIG. 31 is a table showing the particular components present in the test samples of FIGS. 26A-27B and 30;

FIG. 32 is a graph comparing the performance of products including two different films X1 and A1, in accordance with certain configurations;

FIG. 33 is a graph comparing the performance of products including two different films X1 and C1, in accordance with certain configurations;

FIG. 34 is a graph comparing the performance of products including two different films X1 and A1, in accordance with certain configurations;

FIG. 35 is a graph comparing the performance of products including two different films X2 and C1, in accordance with certain configurations; and

FIG. 36 is a graph comparing the performance of products including three different films X2, C2 and C3, in accordance with certain configurations.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular thickness, width or length is intended by the depictions in the figures, and relative sizes of the figure components are not intended to limit the sizes of any of the components in the figures. Where dimensions or values are specified in the description below, the dimensions or values are provided for illustrative purposes only. In addition, no particular material or arrangement is intended to be required by virtue of shading of certain portions of the figures, and even though different components in the figures may include shading for purposes of distinction, the different components can include the same or similar materials, if desired.

### DETAILED DESCRIPTION

Certain embodiments are described below with reference to singular and plural terms in order to provide a user friendly description of the technology disclosed herein. These terms are used for convenience purposes only and are not intended to limit the articles, composites and other subject matter as including or excluding certain features unless otherwise noted as being present in a particular embodiment described herein.

In certain embodiments, the articles described herein can include two or more different components coupled to each other to provide a composite material or article with one or more desired performance characteristics. In certain instances, the composite article can include a thermoplastic core material with one or more additional materials or components disposed on the core material. In some instances, at least one of the additional materials or components disposed on the core material can be a film comprising a tie layer. In some instances, the tie layer can be coupled to another layer comprising a viscosity greater than the viscosity of materials in the tie layer. Reference herein to the term “high viscosity” material refers to the viscosity of the particular material in that layer being higher than the viscosity of materials in an adjacent layer. For example, where a layer comprising a high viscosity material is described, the viscosity of at least one material used in that layer is higher than materials used in other layers of the film. In some instances, the melt flow index of the material present in the high viscosity layer may be less than 1 gram/10 min. as measured using various IPC or ASTM tests, e.g., ASTM D1238 dated 2013, whereas the melt flow index of material present in other layers of the film may be greater than 1, greater than 2, greater than 3, greater than 4 or greater than 5 using the same test used to measure the melt flow index of the high viscosity material. For example, the high viscosity material may comprise a melt flow index of 2× less, 3× less, 4× less or 5× less than the melt flow index of other materials present in other layers of the film (when the melt flow index of the materials are all measured using the same ASTM or IPC test).

In certain embodiments, the tie layer may comprise one or more polymers or copolymers. For example, a polyolefin homopolymer or polyolefin copolymer may be present in the tie layer. In some examples, the homopolymer or copolymer may comprise one or more of polyethylene, polypropylene, polybutylene and combinations and copolymers thereof. Additional materials may also be present in the tie layer of the film if desired.

In some embodiments, the presence of a high viscosity tie layer may permit the use of thicker core layers of a constant density. For example, as the core layer thickness increases with constant density, there may be less material present at the surface to bond to another component. This can result in a decrease in peel strength as a function of an increase in core layer thickness. To avoid having to increase the density for increased thickness, which can also increase the overall weight, an integral tie layer may be used to provide enhanced peel strength. While not required, the presence of an integral tie layer may be desirable for use where it is desired to increase an overall thickness of a core layer without altering its basis weight.

In some instances, the high viscosity layer may comprise a high viscosity polyolefin layer, e.g., a high viscosity polypropylene. By including a layer of such high viscosity in combination with a tie layer in the film, the basis weight of the film can be reduced compared to a film lacking such a high viscosity tie layer. For example, where a composite article comprising a thermoplastic core and a film is used, the basis weight of a film comprising the high viscosity layer and the tie layer may be at least 25% less than a film lacking such a tie layer and/or high viscosity tie layer, and, even though the basis weight of the film with the tie layer is less than that of the film lacking the tie layer, the overall physical properties of the composite article with the high viscosity tie layer film may be the same or even improved. In particular, the film with the tie layer may have a basis weight of 25% less, 30% less, 35%, less, 40% less or even 50% less than that of a comparable film lacking the tie layer while still providing suitable overall performance characteristics to the composite article. As noted in more detail below, the performance characteristics of the composite article can be determined by measuring, for example, one or more of peel strength, acoustic absorption, flame retardancy or other suitable physical properties. In some instances, the peel strength (in either the cross direction, machine direction or both) of the composite article comprising the film with the tie layer is substantially the same as a composite article comprising a comparable film lacking the tie layer even though the overall basis weight of the film with the tie layer is less than that of the film without the tie layer. Peel strength can be measured, for example, by peeling a surface layer from a composite article comprising the core, film and a surface layer, as noted in more detail below. One illustrative test for determining peel strength that can be used in described in ASTM D-903 dated 2004. If desired, the specimen size specified in ASTM D-903 can be reduced to a smaller specimen (1 inches by 6 inches instead of the specific 1 inches by 12 inches) to reduce the amount of article needed for testing.

In some instances, a film with a high viscosity layer and tie layer may have a basis weight of 60 gsm or less, e.g., 30 gsm (grams per square meter) to 60 gsm or 40 gsm to 60 gsm or 50 gsm to 60 gsm. For comparison purposes, typical films that provide a suitable peel strength for the composite article may have a basis weight of 80 gsm, 100 gsm or more. Where bilayer or multilayer films are used, each layer may or may not have the same basis weight as other layers. In some instances, a 3-layer film may comprise a basis weight of about 60 gsm or less or about 80 gsm or less or about 100 gsm or less. In other configurations, a 5-layer film may comprise a basis weight of about 60 gsm or less or about 80 gsm or less or about 100 gsm or less. In some embodiments, an adhesive layer of the film may comprise a basis weight of about 30 gsm and the balance of the basis weight, e.g., about 30-70 gsm, may be from the other components of the film.

In some configurations, the film comprises a high viscosity layer and a tie layer each of which comprises one or more thermoplastic materials. In some instances, the thermoplastic material of the tie layer may also be present as a component or material in the high viscosity layer. For example, a polyolefin of a first type may be present in a high viscosity layer and the same type of polyolefin may be present in a tie layer of the film but at a lower viscosity. In some instances the tie layer of the film may comprise a polyolefin homopolymer or polyolefin copolymer, e.g., a homopolymer or copolymer of polypropylene that provides the desired tie layer effects. Where a tie layer is present, it may be present in a film comprising at least one additional layer (e.g., a bilayer film) or two or more additional layers.

In certain embodiments, the tie layer of the films described herein may be present as a center layer in the film to provide enhanced adhesion between the film components. For example, where the film takes the form of a 3-layer film, the tie layer can be present in the middle layer. Where the film takes the form of a 5-layer film, a first tie layer can be present between the outer layer and a center layer, and a second tie layer can be present between a center layer and an inner layer. If even numbers of layers are present in the film, the tie layer can be present between any of the layers. As discussed in more detail herein, the exact thickness of the various layers of the film can be the same or can be different, and in some instances the tie layer comprises a lower thickness than other layers of the film.

In some instances, the film may have an overall basis weight of about 60 gsm or less and be configured as a bilayer film with each layer of the bilayer contributing about 50% of the basis weight. The thickness of the different layers need not be the same to provide about 50% of the basis weight. In some configurations, a multilayer film can also be used with each layer of the multilayer film providing about the same percentage basis weight to the overall film basis weight.

In other instances, the film may comprise 3-layers, 4-layers, 5-layers or more than 5-layers. For example, the film may be a multi-layer film with one or more of the layer being a tie layer. In some instances, one layer of the film may comprise one or more a polyamide materials or a copolymer comprising a polyamide material. If desired, the polyamide material may be linear or cyclic. For example, a 3-layer film may comprise a polyamide material or a copolymer comprising a polyamide material in at least one of the layers. In some instances where a 3-layer film comprising a polyamide is present, the polyamide may be a linear polyamide. In other instances, where a 3-layer film comprising a polyamide is present, the polyamide may be a cyclic polyamide. For example, a 3-layer film comprising a linear or cyclic polyamide, or both, in one or more of the film layers may be present. Where a cyclic polyamide is present in a 3-layer film, in some configurations, the cyclic polyamide may be any cyclic polyamide other than caprolactam. In other examples, a 4-layer film may comprise a polyamide material or a copolymer comprising a polyamide material in at least one of the layers. In some instances where a 4-layer film comprising a polyamide is present, the polyamide may be a linear polyamide. In other instances, where a 4-layer film comprising a polyamide is present, the polyamide may be a cyclic polyamide. For example, a 4-layer film comprising a linear or cyclic polyamide, or both, in one or more of the film layers may be present. Where a cyclic polyamide is present in a 4-layer film, in some configurations, the cyclic polyamide may be any cyclic polyamide other than caprolactam. In other embodiments, a 5-layer film may comprise a polyamide material or a copolymer comprising a polyamide material in at least one of the layers. In some instances where a 5-layer film comprising a polyamide is present, the polyamide may be a linear polyamide. In other instances, where a 5-layer film comprising a polyamide is present, the polyamide may be a cyclic polyamide. For example, a 5-layer film comprising a linear or cyclic polyamide, or both, in one or more of the film layers may be present. Where a cyclic polyamide is present in a 5-layer film, in some configurations, the cyclic polyamide may be any cyclic polyamide other than caprolactam. In other configurations, a film with more than 5 layers may comprise a polyamide material or a copolymer comprising a polyamide material in at least one of the layers. In some instances where more than 5-layer film comprising a polyamide is present, the polyamide may be a linear polyamide. In other instances, where a more than 5-layer film comprising a polyamide is present, the polyamide may be a cyclic polyamide. For example, a more than 5-layer film comprising a linear or cyclic polyamide, or both, in one or more of the film layers may be present. Where a cyclic polyamide is present in a more than 5-layer film, in some configurations, the cyclic polyamide may be any cyclic polyamide other than caprolactam.

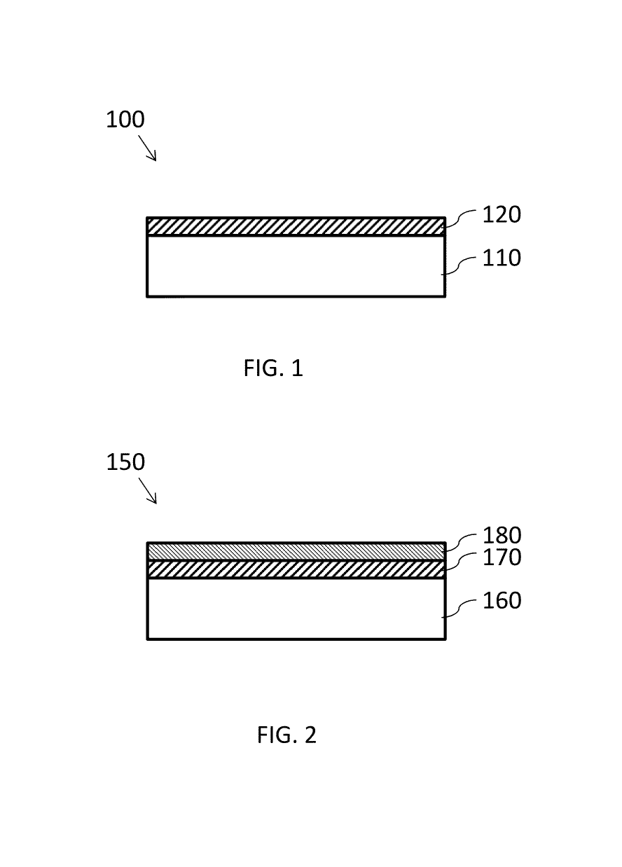

In certain embodiments and referring to FIG. 1, a simplified illustration of a composite article is shown. The article 100 comprises a core layer 110 and a film 120 disposed on the core layer 110. While the simplified illustration in FIG. 1 shows the film 120 covering an entire upper surface of the layer 110, if desired, the film 120 may only partially cover some portion of a surface of the core layer 110, e.g., the film may cover 50% or less of a first or top surface of the core layer 110. In other instances, strips of the film material can be placed on different areas of the surface of the core layer 110. In certain instances, the core layer may comprise a thermoplastic material, e.g., a thermoplastic resin or thermoplastic fibers or both, and one or more types of reinforcing fibers dispersed in the thermoplastic material. As described in more detail below, the core layer 110 is typically permeable or porous and includes a void content greater than 0%.

In certain configurations, the film 120 of the composite article 100 may comprise two or more layers. The layers may be connected or coupled to each other by way of a tie layer, or in other instances, the tie layer can be present as one layer of the film 120. For example, in certain instances, the tie layer may be one layer in a bilayer film or the tie layer may be one layer in a 3-layer film, a 4-layer film, a 5-layer film or more than a 5-layer film. As noted herein, the film 120 may comprise a linear or cyclic polyamide, e.g., a linear or cyclic polyamide optionally without any caprolactam present. The tie layer may comprise a material with a suitable viscosity to provide a desired peel strength to the composite article 100 when an additional cover or surface layer is disposed on the film layer 120. For example and referring to FIG. 2, an article 150 comprising a core layer 160, a film 170 and a cover layer 180 is shown. The tie layer of the film 170 may comprise a material that can provide adhesion to bond the cover layer 180 to the film 170 and/or core layer 160 to provide a suitable peel strength to the article 150. In some instances, the peel strength of the article 150 may be 5-6 N/cm or more in the machine direction and the cross direction when tested under ambient conditions or under humidified conditions. The film 170 may be a bilayer, a 3-layer film, a 4-layer film, a 5-layer film or more than a 5-layer film. As noted herein, the film 170 may comprise a linear or cyclic polyamide, e.g., a linear or cyclic polyamide optionally without any caprolactam present.

In certain configurations, the thickness of the core layers in the articles described herein can vary from about 1 mm to about 10 mm, for example about 2 mm to about 8 mm, e.g., about 3 mm to about 6 mm. The basis weight of the core layer typically varies from about 600 gsm to about 3500 gsm, more particularly, about 600 gsm to about 2000 gsm, e.g., about 600 gsm to about 1200 gsm or about 600 gsm to about 800 gsm. The thickness of the film comprising the integral tie layer is typically about 10 microns to about 1 mm, more particularly about 30 microns to about 500 microns, e.g., about 50 microns to about 100 microns. The basis weight of the film comprising the integral tie layer is typically about 20 gsm to about 100 gsm, more particularly about 30 gsm to about 60 gsm, e.g., about 45-60 gsm.

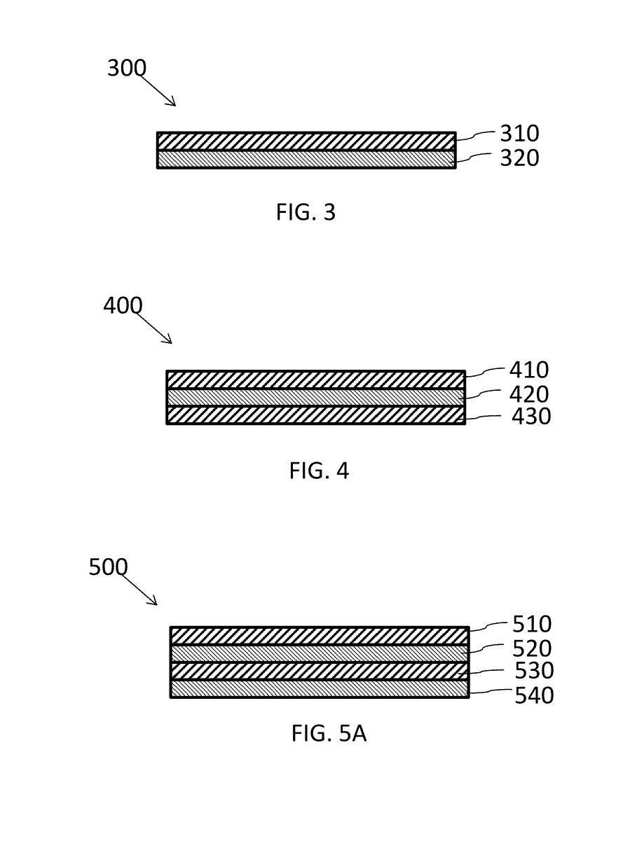

In certain examples and referring to FIGS. 3 and 4, illustrations of films are shown in more detail. Referring to FIG. 3, a bilayer film 300 comprises a first layer 310 and a second layer 320. In some instances, the first layer 310 and the second layer 320 may comprise at least one common material, whereas in other instances no common material may be present in the layers 310, 320. In certain embodiments, at least one of the layers 310, 320 comprises a polyamide material or a copolymer comprising a polyamide, e.g., a linear or cyclic polyamide optionally without any caprolactam present. In other configurations, at least one of the layers 310, 320 can function as a tie layer. Additional materials for the film layers are described in more detail below. In other configurations, one or both of the layers 310, 320 may comprise a non-polar material or may be present as a non-polar layer. For example, where a non-polar layer is present the layer may comprise a polyolefin such as, for example, a polyethylene, a polypropylene or other hydrocarbon based (saturated or unsaturated) materials. As noted herein, one of the layers 310, 320 may comprise a polyolefin material or a copolyamide material or another material that is functional as a tie layer in the film 300. In some instances, the layer 310 may be effective to provide adhesion (at a processing temperature) to assist in bonding any cover layer or additional layer (not shown) to the composite article comprising the film 300. In certain configurations, the layer 310 comprises one or more copolymers that provide adhesion to bond the cover layer or additional layers to the composite article. In some examples, the viscosity of the layer 320 can be selected to be high enough such that the materials do not migrate or move very much at a processing temperature. Where low viscosity materials are used, the materials can easily absorb into the core layer and/or the cover layer and not provide a suitable degree of bonding between the core layer and/or cover layer. The use of a high viscosity layer as (or in) the layer 320 permits, for example, the use of lower amounts of materials in the layer 310 and reduction of the overall basis weight of the film 300 without a substantial sacrifice in performance. While the layer 310 is shown being positioned above the layer 320, the configuration may be reversed where the materials present in the layer 320 may instead be disposed on the layer 310.

In certain examples, illustrative materials that can be included in the layer 310 (where the layer 320 is functional as a tie layer) include, for example, polyamide, copolyamides, and mixtures of other materials with a polyamide or a copolyamide. Optionally, one or both of the layers 310, 320 may be present without any caprolactam in the layers 310, 320. In some instances, the polyamide or copolyamide may be present in a major amount, e.g., present at 50% by weight or more based on the weight of the layer 310, whereas in other examples, the polyamide or copolyamide may be present in a minor amount, e.g., present at less than 50% by weight based on the weight of the layer 310. Instead of including a polyamide or copolyamide in the layer 310 (or in addition to the polyamide or copolyamide in the layer 310), materials such as esters, polyesters, olefins, polyolefins, acrylates, polyacrylates, acetates, polyacetates, urethanes, polyurethanes, block copolymers lactones, halopolymers (which may impart some flame retardancy to the tie layer), elastomers such as natural or synthetic rubber, and additives such as tackifying agents, plasticizers, UV stabilizers, antioxidants, pigments, dyes, flame retardants, antistatic agents, biocidal agents (e.g., antibacterial or antifungal agents), fillers, whiskers, powders, particles (e.g., electrically conductive particles or non-electrically conductive particles), odorants, colorants or other materials may also be present in the layer 310 if desired.

In certain embodiments, each layer of the film 300 may be present at about the same thickness, whereas in other instances, the thickness of one of the layers 310, 320 may be greater than the other layers. Similarly, the basis weight of the two layers 310, 320 may be the same or may be different. In some instances, each layer of the film 300 may have a basis weight of about 20-30 gsm. In other instances, the basis weight of the layer 310 accounts for at least 50% of the overall basis weight of the film 300, more particularly the layer 310 accounts for at least 60% of the overall basis weight of the film 300 or at least 75% of the overall basis weight of the film 300. In some instances, the tie layer 320 may account for at least 50% of the overall basis weight of the film 300, more particularly the layer 320 accounts for at least 60% of the overall basis weight of the film 300 or at least 75% of the overall basis weight of the film 300. These basis weight values refer to the basis weight prior to processing of the film 300, and the resulting basis weight may change after processing of the article including the film.

In certain configurations, the layer 320 may comprise one or more polymers or copolymers that impart a high viscosity to the layer 320. In certain examples, the viscosity of the materials used in the layer 320 can be selected so it is greater than the viscosity of materials in the layer 310. Viscosity of the materials can be measured by many tests including, for example, ASTM D1084 dated 2008. The reference herein to viscosity of the layer refers to measurement of the viscosity of the materials present in the layer and not necessarily measurement of the viscosity of the layer itself when present in the film.

In some embodiments, the layer 320 may comprise one or more thermoplastic materials including, but not limited to, a polyolefin such as, for example, polyethylene, polypropylene, polymethylpentene, polybutene-1 or elastomers or derivatives of polyolefins such as, for example, polyisobutylene, propylene rubber, ethylene rubber, ethylene propylene rubber and other polymers formed by reaction of an elastomer such as a natural or synthetic rubber with a polyolefin. While not wishing to be bound by any particular theory, the layer 320 can generally be a non-polar, non-permeable and/or non-porous such that fluids do not readily pass into, or are absorbed by, the layer 310. The non-permeability of the layer 320 acts to reduce or prevent absorption of the layer 320 into the permeable core layer of the article. In certain instances, the materials of the layer 310 are selected to have a melting point higher than the melting point of materials in the layer 320 such that the film can be heated to soften the layer 320 without substantial softening of the layer 310. In other instances, the layer 320 may include materials with a melting point below materials in the layer 310, e.g., to bond the layer 320 to a coupled core layer by way of heating the core layer with the film disposed thereon. In some instances, the layer 320 may be light activated to provide a bond to an underlying core layer 320, and the layer 310 may be heat activated. While not required, where the film 300 is disposed on a core layer (not shown), the tie layer 320 is generally disposed adjacent to the core layer such that the layer 320 is positioned between the layer 310 and any core layer.

In certain instances, the layers 310, 320 together (optionally with a tie layer between them where a tie layer is not present as a layer 310, 320) can provide a film 300 which is generally not permeable to air, smoke, liquid or other fluids and that is functional to provide such a fluid barrier and can adhesively couple an underlying core layer to an additional layer in a composite article. For example, during processing, a film comprising the layers 310, 320 can be placed or disposed on a core layer. A cover layer can then be placed on the disposed film and adjacent to the layer 310. Pressure, heat or both can be applied to the article to melt the film tie layer (at least to some degree) and bond the cover layer to the core layer through the high viscosity tie layer of the film 300. Illustrative pressures and processing temperatures are discussed in more detail herein. Depending on the desired configuration, the layer 310 may be adjacent to an underlying core layer, or the layer 320 may be adjacent to an underlying core layer. In some instances, the layer 320 couples to the core layer, and the layer 310 couples to a surface or cover layer of the article, e.g., the layer 310 may comprise a polyamide that is used to bond the film to a cover layer. In some instances, the layer 310, 320 which is furthest from the core (depending on the orientation of the film 300), e.g., which is present on an outer surface that can be coupled to another component such as a surface or decorative covering, may comprise a polyamide, a copolyamide or combinations thereof, e.g., a linear or cyclic polyamide optionally without any caprolactam. For example, layer 320 may comprise a polyamide instead of layer 310 or both layers 310, 320 may each comprise a polyamide such as a linear or cyclic polyamide, e.g., optionally without any caprolactam.

Referring now to FIG. 4, a multilayer film 400 is shown comprising three layers 410, 420 and 430. In some instances, one of the layers is a tie layer and the other two layers are not tie layers, e.g., the layer 420 may be functional as a tie layer. In other instances, two of the layers are tie layers. In some instances, the layer 410 may be effective to function to provide adhesion (at one or more processing temperatures) to assist in bonding of a cover layer or other layer to the composite article. The layer 430 can be present to assist in bonding of the film 400 to an underlying core layer. If desired, the layers 420, 430 can include similar materials or different materials, e.g., the layer 420 and 430 may comprise one or more thermoplastic materials such as, for example, a polyolefin. For example, the layers 420, 430 may comprise materials including, but not limited to, a polyolefin such as, for example, polyethylene, polypropylene, polymethylpentene, polybutene-1 or elastomers or derivatives of polyolefins such as, for example, polyisobutylene, propylene rubber, ethylene rubber, ethylene propylene rubber and other polymers formed by reaction of an elastomer such as a natural or synthetic rubber with a polyolefin. While not wishing to be bound by any particular theory, the layer 420 or the layer 430 or both can generally be non-polar, non-permeable and/or non-porous such that fluids do not readily pass into, or are absorbed by, the layer 420 or the layer 430. The non-permeability of the layer 420 (or 430) acts to reduce or prevent absorption of the particular layer 410 or 430 (that couples to the cover layer) into the permeable core layer of the article. In certain instances, the materials of the layer 430 are selected to have a viscosity higher than the viscosity of materials in the layers 410, 420. In other configurations, the material used in the layer 420 may have a higher viscosity than the material used in the layers 410, 430. In some instances, the layers 420, 430 comprise a common material, e.g., a polyolefin such as polypropylene, but the viscosities of the materials are different in the different layers 420, 430.

In some configurations, the layer 430 comprises a high viscosity material as described herein, whereas the layer 420 does not include a high viscosity material as described herein. In such configurations, the layer 410 can be placed adjacent to a cover layer, and the layer 430 can be placed adjacent to a core layer. If desired, however, the configuration may be flipped where the layer 430 is placed adjacent to a cover layer, and the layer 410 can be placed adjacent to a core layer. In other configurations, each of the layers 420, 430 may comprise a high viscosity material as described herein, e.g., a high viscosity polyolefin. As noted herein, as the term “high” is a term of degree, reference to the term “high viscosity” herein means that the viscosity is higher than other materials in other layers of the film. In some instances, the layer 430 comprises a high viscosity polypropylene (or other polyolefin) and the layer 420 comprises polypropylene (or other polyolefin) with a lower viscosity than the polypropylene in the layer 430. The layer 410 may comprise a polyamide, a copolyamide, and mixtures of other materials with a polyamide or a copolyamide. For example, the layer 410 may comprise a linear or cyclic polyamide or copolyamide optionally without any caprolactam being present. In some instances, the polyamide or copolyamide may be present in a major amount, e.g., present at 50% by weight or more based on the weight of layer 410, whereas in other examples, the polyamide or copolyamide may be present in a minor amount, e.g., present at less than 50% by weight based on the weight of the layer 410. Instead of including a polyamide or copolyamide in the layer 410 (or in addition to including a polyamide or copolyamide in the layer 410), materials such as esters, polyesters, olefins, polyolefins, acrylates, polyacrylates, acetates, polyacetates, urethanes, polyurethanes, block copolymers lactones, halopolymers (which may impart some flame retardancy to the tie layer), elastomers such as natural or synthetic rubber, and additives such as tackifying agents, plasticizers, UV stabilizers, antioxidants, pigments, dyes, flame retardants, antistatic agents, biocidal agents (e.g., antibacterial or antifungal agents), fillers, whiskers, powders, particles (e.g., electrically conductive particles or non-electrically conductive particles), odorants, colorants or other materials may also be present in the layer 410 (and/or in the layers 420, 430) if desired. If desired, a polyamide or copolyamide (e.g., a linear or cyclic polyamide or copolyamide optionally without any caprolactam) may be present in one or both of the layers 420, 430 or in each of the layers 410, 420 and 430. In some instances, the layer 410, 430 which is furthest from the core (depending on the orientation of the film 400), e.g., which is present on an outer surface that can be coupled to another component such as a surface or decorative covering, may comprise a polyamide, a copolyamide or combinations thereof, e.g., a linear or cyclic polyamide optionally without any caprolactam. For example, layer 430 may comprise a polyamide instead of layer 410 or both layers 410, 430 may each comprise a polyamide such as a linear or cyclic polyamide, e.g., optionally without any caprolactam.

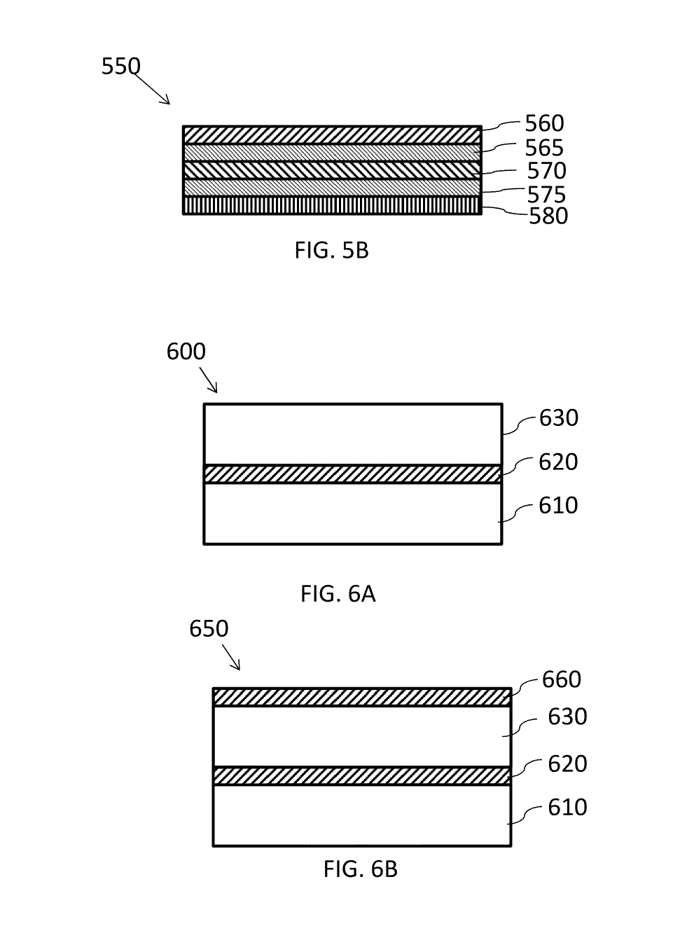

In certain examples and referring to FIG. 5A, one illustration of a multi-layer film 500 is shown. The film 500 comprises layers 510, 520, 530 and 540. Any one or more of the layers 520-540 may each be effective to function as a tie layer, e.g., similar to layer 420. In some instances, at least one of the layers 520-540 is a tie layer and at least one other layer is a high viscosity layer as described herein. In certain configurations, the layer 520 is a tie layer, and the layer 530 is a high viscosity layer. If desired, the layer 540 can be another tie layer, a high viscosity layer or a layer comprising other properties and/or materials. In other configurations, at least two of the layers 520-540 comprise a high viscosity material to permit the two layers to function as high viscosity tie layers. For example, layers 520 and 540 may comprise a high viscosity material and the layer 530 may be functional as a tie layer. The high viscosity material in different layers may be the same or may be different. If desired, one or two of the layers 520-540 can be permeable or porous and the other layer or layers 520-540 can be impermeable. In alternative configurations, each of the layers 520-540 can be permeable or porous, or each of the layers 520-540 can be impermeable. In some instances, each of the layers 520-540 may independently comprise one or more thermoplastic materials including, but not limited to, a polyolefin such as, for example, polyethylene, polypropylene, polymethylpentene, polybutene-1 or elastomers or derivatives of polyolefins such as, for example, polyisobutylene, propylene rubber, ethylene rubber, ethylene propylene rubber and other polymers formed by reaction of an elastomer such as a natural or synthetic rubber with a polyolefin. While not wishing to be bound by any particular theory, each of the layers 520-540 can be configured as a substantially non-polar, non-permeable and/or non-porous layer such that fluids do not readily pass into, or are absorbed by, the layers 520-540. The non-permeability of the layers 520-540 can act, for example, to reduce or prevent absorption of the layers 510 into the permeable core layer of the article. In certain instances, the materials in certain layers of the layers 510-540 can be selected to have a melting point higher than the melting point of materials in other the layers such that the film can be heated to soften certain layers without substantial softening of other layers. In some embodiments, the layers 520 and 540 may each comprise a polypropylene, but the viscosity of polypropylene used in the layer 520 may be higher than the polypropylene used in the layer 540. In other instances, the layers 520 and 540 may each comprise a polypropylene, but the viscosity of polypropylene used in the layer 540 may be higher than the polypropylene used in the layer 520.

In certain examples, the layer 510 may comprise a polyamide, a copolyamide, and mixtures of other materials with a polyamide or a copolyamide, e.g., the layer 510 may comprise a linear or cyclic polyamide optionally without any caprolactam. In some instances, the polyamide or copolyamide may be present in a major amount, e.g., present at 50% by weight or more based on the weight of the layer 510, whereas in other examples, the polyamide or copolyamide may be present in a minor amount, e.g., present at less than 50% by weight based on the weight of the layer 510. Instead of including a polyamide or copolyamide in the layer 510 (or in addition to the polyamide or copolyamide in the layer 510), materials such as esters, polyesters, olefins, polyolefins, acrylates, polyacrylates, acetates, polyacetates, urethanes, polyurethanes, block copolymers lactones, halopolymers (which may impart some flame retardancy to the tie layer), elastomers such as natural or synthetic rubber, and additives such as tackifying agents, plasticizers, UV stabilizers, antioxidants, pigments, dyes, flame retardants, antistatic agents, biocidal agents (e.g., antibacterial or antifungal agents), fillers, whiskers, powders, particles (e.g., electrically conductive particles or non-electrically conductive particles), odorants, colorants or other materials may also be present in the layers 510 if desired. As noted herein, the layer 510 need not be the same and may include different materials, e.g., different polyamides, different co-polyamides or different additives or both, if desired. If desired, a polyamide or copolyamide (e.g., a linear or cyclic polyamide or copolyamide optionally without any caprolactam) may be present in one or more of the layers 520, 530, 540 (instead of in the layer 510) or in each of the layers 510, 520, 530 and 540. In some instances, the layer 510, 540 which is furthest from the core (depending on the orientation of the film 500), e.g., which is present on an outer surface that can be coupled to another component such as a surface or decorative covering, may comprise a polyamide, a copolyamide or combinations thereof, e.g., a linear or cyclic polyamide optionally without any caprolactam. For example, layer 540 may comprise a polyamide instead of layer 510 or both layers 510, 540 may each comprise a polyamide such as a linear or cyclic polyamide, e.g., optionally without any caprolactam.

Referring now to FIG. 5B, another illustration of a multilayer film 500 comprising five layers is shown. The film 550 comprises layers 560-580. The layer 560 may be similar to the layer 510 as described above. For example, the layer 560 may comprise a polyamide, a copolyamide, and mixtures of other materials with a polyamide or a copolyamide, e.g., the layer 560 may comprise a linear or cyclic polyamide optionally without any caprolactam. In some instances, the polyamide or copolyamide may be present in a major amount, e.g., present at 50% by weight or more based on the weight of the layer 560, whereas in other examples, the polyamide or copolyamide may be present in a minor amount, e.g., present at less than 50% by weight based on the weight of the layer 560. Instead of including a polyamide or copolyamide in the layer 560 (or in addition to the polyamide or copolyamide in the layer 560), materials such as esters, polyesters, olefins, polyolefins, acrylates, polyacrylates, acetates, polyacetates, urethanes, polyurethanes, block copolymers lactones, halopolymers (which may impart some flame retardancy to the tie layer), elastomers such as natural or synthetic rubber, and additives such as tackifying agents, plasticizers, UV stabilizers, antioxidants, pigments, dyes, flame retardants, antistatic agents, biocidal agents (e.g., antibacterial or antifungal agents), fillers, whiskers, powders, particles (e.g., electrically conductive particles or non-electrically conductive particles), odorants, colorants or other materials may also be present in the layers 560 if desired. The layer 560 need not be the same and may include different materials, e.g., different polyamides, different co-polyamides or different additives or both, if desired. If desired, layer 565-580 can also include a polyamide or copolyamide, e.g., a linear or cyclic polyamide optionally without any caprolactam, or layer 580 may instead comprise the polyamide or copolyamide materials, e.g., layer 580 may comprise (instead of or in addition to the polyamide in layer 510) a linear or cyclic polyamide optionally without any caprolactam.

In some examples, at least one of the layers 565-580 may be a high viscosity layer and at least one of the layers 565-580 may be a tie layer. In some instances, the high viscosity layer is layer 565. In other instances, the high viscosity layer is layer 570. In other embodiments, the high viscosity layer is layer 575. In further examples, the high viscosity layer is layer 580. In some instances, the tie layer is layer 565. In other instances, the tie layer is layer 570. In other embodiments, the tie layer is layer 575. In further examples, the tie layer is layer 580. In certain configurations, a tie layer can be present between layers of the film. For example, each of the layers 565 and 575 can function as tie layers. In some embodiments where the film comprises an odd number of layers, the high viscosity layer may be present as the central layer in the layered stack. For example, the high viscosity layer can be present as the layer 570 optionally with tie layers being present as each of layers 565, 575. In some embodiments, the layers 570 and 580 may comprises at least one common material, e.g., a polyolefin, but the viscosity of the materials in the layers 570, 580 can be different, e.g., the viscosity can be higher in the layer 570 than in the layer 580 or vice versa. In some instances, each of the layers 565-580 may independently comprise one or more thermoplastic materials including, but not limited to, a polyolefin such as, for example, polyethylene, polypropylene, polymethylpentene, polybutene-1 or elastomers or derivatives of polyolefins such as, for example, polyisobutylene, propylene rubber, ethylene rubber, ethylene propylene rubber and other polymers formed by reaction of an elastomer such as a natural or synthetic rubber with a polyolefin. In some instances, the layer 560 may comprise a polyamide, the layers 565, 575 can function as tie layers and the layers 570, 580 may comprise polypropylene with the viscosity of polypropylene used in the layer 570 being higher than the viscosity of polypropylene used in the layer 580. In some instances, the layer 560, 580 which can be furthest from the core (depending on the orientation of the film 550), e.g., which is present on an outer surface that can be coupled to another component such as a surface or decorative covering, may comprise a polyamide, a copolyamide or combinations thereof, e.g., a linear or cyclic polyamide optionally without any caprolactam.

In certain instances, any of the layers in FIGS. 3-5B may independently comprise one or more materials to impart a desired property or characteristic. For example, the layers 310, 410, 510 and 540 independently can include particles, powders, whiskers, fillers, binders, fibers or other materials that can impart desired physical properties to the films. In certain embodiments, flame retardant materials such as halogenated materials, phosphorated materials, nitrogenated materials or other suitable flame retardants can be added to the layers 310, 410, 510 or 540. In further embodiments, smoke suppressants, oxygen scavengers, ultraviolet light inhibitors, dyes, colorants, pigments or other materials can be added to the layers 310, 410, 510 or 540. If desired, an outermost layer of the film (the layer further from the core after the film is coupled to a core) may comprise particles, powders, whiskers, fillers, binders, fibers or other materials that can impart desired physical properties to the films. In certain embodiments, flame retardant materials such as halogenated materials, phosphorated materials, nitrogenated materials or other suitable flame retardants, smoke suppressants, oxygen scavengers, ultraviolet light inhibitors, dyes, colorants, pigments or other materials.

Referring again to FIGS. 1 and 2, in certain embodiments, the core layers, e.g., core layers 110 or 160, of the composite articles described herein typically include one or more thermoplastic materials, e.g., thermoplastic resins in powder form or fiber form or other forms, in combination with a plurality of reinforcing materials such as reinforcing fibers. In some instances, the reinforcing materials and the fibers together form a web comprising a plurality of void spaces to impart a porous nature to the core layer, e.g., a web is formed from the reinforcing fibers and the thermoplastic materials. The void space generally does not add any weight to the core layer but can increase the overall thickness of the core layer. In some instances, the core layer may comprise a porosity of at least 5%, 10%, 15%, 20%, 25%, 30%, 35%, 40%, 45%, 50%, or more than 50%, e.g., 55-95% or 75-95% porosity, based on the total volume of the core layer. In other instances, the porosity of the core layer may be about 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. If desired the porosity of the core or the overall composite may be greater than 95%, e.g., may be about 96% or 97%.

In certain configurations, the core layer 110 or 160 can have a density about 0.1 gm/cc to about 2.0 gm/cc, e.g., about 0.1 gm/cc to about 1.0 gm/cc or about 0.3 gm/cc to about 1.5 gm/cc or about 0.5 gm/cc to about 1.0 gm/cc or about 1.0 gm/cc to about 1.5 gm/cc or about 1.5 gm/cc or about 2.0 gm/cc. The core layers of the articles described herein can be produced using known manufacturing process, for example, a wet laid process, an air laid process, a dry blend process, a carding and needle process, and other known process that are employed for making non-woven products. Combinations of such manufacturing processes are also useful.

In certain examples, the thermoplastic material of the core layer can take many different forms and configurations including a thermoplastic resin in powder form or in fiber form. Depending on the processing conditions used, it may be desirable to select one form over another. Illustrative thermoplastic materials include, but are not limited to, a polyolefin, polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyetherimides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. In some instances, the thermoplastic material is present in particulate, fiber or powder form. The particles need not be excessively fine, but particles coarser than about 1.5 millimeters can be less desirable in that they may not flow sufficiently during the molding process to produce a homogenous structure. The use of larger particles can result in a reduction in the flexural modulus of the material when consolidated. In one selection, the particles are not more than about 1 millimeter in size. In other instances, the thermoplastic material can take the form of thermoplastic fibers such as, for example, the polyimides and polysulfone materials described in U.S. Patent Publication No. 20120065283 or U.S. Patent Publication No. 20130244528, the entire disclosure of each of which is hereby incorporated herein by reference.

In some embodiments, the core layers of the articles described herein can include one or more types of fibers. Illustrative types of fibers include, but are not limited to, glass fibers, carbon fibers, graphite fibers, thermoplastic fibers, synthetic organic fibers, particularly high modulus organic fibers such as, for example, para- and meta-aramid fibers, nylon fibers, polyester fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, the fibers can be chemically treated prior to use to provide desired functional groups or to impart other physical properties to the fibers. The fiber content in the polymer core may be from about 20% to about 90%, more particularly from about 30% to about 70%, by weight of the polymer core. Typically, the fiber content of the composite varies between about 20% to about 90% by weight, more particularly between about 40% to about 80% by weight of the composite. The particular size and/or orientation of the fibers used may depend, at least in part, on the polymer material used and/or the desired properties of the resulting composite. Suitable additional types of fibers, fiber sizes and amounts will be readily selected by the person of ordinary skill in the art, given the benefit of this disclosure. In one non-limiting illustration, fibers dispersed within a thermoplastic resin or thermoplastic fibers of the core, for example, generally have a diameter of greater than about 5 microns, more particularly from about 5 microns to about 22 microns, and a length of from about 5 mm to about 200 mm; more particularly, the fiber diameter may be from about microns to about 22 microns and the fiber length may be from about 5 mm to about 75 mm.

In certain configurations, the core layers can include about 20% to about 80% by weight reinforcing fibers having a high tensile modulus of elasticity and an average length of between about 7 and about 200 mm, and about 20% to about 80% by weight of a wholly or substantially unconsolidated fibrous or particulate thermoplastic materials, where the weight percentages are based on the total weight of core layer. In another embodiment, core layer includes about 35% to about 55% by weight fibers. The web can be heated above the melting point of the thermoplastic materials of the core layer to substantially soften the plastic materials and is passed through one or more consolidation devices, for example nip rollers, calendaring rolls, double belt laminators, indexing presses, multiple daylight presses, autoclaves, and other such devices used for lamination and consolidation of sheets and fabrics so that the plastic material can flow and wet out the fibers. The gap between the consolidating elements in the consolidation devices are set to a dimension less than that of the unconsolidated web and greater than that of the web if it were to be fully consolidated, thus allowing the web to expand and remain substantially permeable or porous after passing through the rollers. In one embodiment, the gap is set to a dimension about 5% to about 10% greater than that of the web if it were to be fully consolidated. A fully consolidated web means a web that is fully compressed and substantially void free. A fully consolidated web would have less than 5% void content, e.g., about 0% void content, and have negligible open cell structure.

In certain embodiments, traditional glass fiber composites used in exterior structural applications can be generally compression flow molded and can be substantially void free in their final part shape. By comparison, low density glass fiber composites used in automotive interior applications can be generally semi-structural in nature and can be porous and lightweight with densities ranging from 0.1 to 1.8 g/cm³ and containing 5% to 95% voids distributed uniformly through the thickness of the finished part. Certain automotive specifications desire light weight, good flexural, impact, and other mechanical properties, as well as good thermoformability characteristics and/or improved mechanical properties. While such lightweight parts may be particularly desirable in interior automotive applications, similar composite article can also find use in structural applications such as siding, sheathing, wallboards and other building products.

In certain embodiments, an outer surface layer or cover layer can be disposed or otherwise present on one or both sides of the core material or select areas or portions thereof. In some instances, a cover layer is coupled to the film as shown in the composite article of FIG. 2. While the exact nature of the cover layer can vary, in certain instances, the cover layer may comprise a urethane, a polyurethane, a fabric, a foil, a non-woven material, a woven material, a thermoplastic material or other materials. Where the composite article is configured for use in interior applications of automotive vehicles, a fabric can be placed adjacent to the film comprising the high viscosity tie layer. The fabric may provide, for example, a smooth and aesthetically pleasing surface for the interior automotive parts. Illustrative interior automotive parts include, but are not limited to, headliners, floor carpeting, dash materials and dashboards, seats and seat backs, interior consoles, door liners, trunk liners, hood liners, sound absorption shields or materials or other parts of a vehicle that are not exposed to the ambient environment during operation. If desired, however, the articles described herein could be used in exterior automotive applications such as, for example, bumper covers, under body shields, wheel liners, trunk liners, sound proofing liner or layers and the like. In certain configurations, the film layer adjacent to the cover layer may comprise a linear or cyclic polyamide or copolymer comprising a polyamide, e.g., a polyamide optionally without any caprolactam.

In certain examples, the composite can provide improved mechanical properties including improved peel strength at a lower basis weight or other suitable mechanical properties which are improved in the composite. While not required, more than a single mechanical property can be improved by using one or more films with a high viscosity tie layer in the composite articles described herein, e.g., an increase in peel strength, lowering of basis weight and increased longevity of the composite noted herein may be improved individually or in any combination with each other.

In certain embodiments, the composite articles described herein can comprise a glass mat thermoplastic composite (GMT) or a light weight reinforced thermoplastic composite (LWRT). One such LWRT is prepared by HANWHA AZDEL, Inc. and sold under the trademark SUPERLITE® mat. Preferably, the areal density of such a LWRT is from about 400 grams per square meter of the LWRT to about 4000 gsm, although the areal density may be less than 400 gsm or greater than 4000 gsm depending on the specific application needs. In some embodiments, the upper density can be less than about 4000 gsm. Where a LWRT core is used in combination with a film comprising a high viscosity tie layer, the basis weight of the LWRT can be reduced to less than 600 gsm or 400 gsm, for example, without sacrificing desired physical properties.

In certain examples, the LWRT composite can be generally prepared using chopped glass fibers, a thermoplastic material and a thermoplastic polymer film or films and or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend are can be used as the high melt flow index resin. To produce the glass mat, a resin, reinforcing materials and/or other additives can be added or metered into a dispersing foam contained in an open top mixing tank fitted with an impeller. Without wishing to be bound by any particular theory, the presence of trapped pockets of air of the foam can assist in dispersing the glass fibers and high melt flow index resin. In some examples, the dispersed mixture of glass and resin can be pumped to a head-box located above a wire section of a paper machine via a distribution manifold. The foam, not the glass fiber or resin, can then be removed as the dispersed mixture is provided to a moving wire screen using a vacuum, continuously producing a uniform, fibrous wet web. The wet web can be passed through a dryer at a suitable temperature to reduce moisture content and to melt or soften the resin. When the hot web exits the dryer, a surface layer such as, for example, a film comprising a high viscosity tie layer may be laminated onto the web by passing the web of glass fiber, thermoplastic resin and film through the nip of a set of heated rollers. If desired, additional layers such as, for example, a non-woven and/or woven fabric layer may also be attached along with the film to one side or to both sides of the web to facilitate ease of handling the glass fiber-reinforced mat. The composite can then be passed through tension rolls and continuously cut (guillotined) into the desired size for later forming into an end product article. Further information concerning the preparation of such LWRT composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865.

In certain instances, the core layers described herein can be produced, for example, by adding the thermoplastic materials, e.g., thermoplastic resin powder or thermoplastic resin fibers, along with the reinforcing fibers to an agitated aqueous foam which can contain a surfactant. The components are agitated for a sufficient time to form a dispersed mixture of the reinforcing fibers and thermoplastic material in the aqueous foam. The dispersed mixture is then laid down on any suitable support structure, for example, a wire mesh, and then the water is evacuated through the support structure forming a web. The web can be dried and heated above the softening temperature of the thermoplastic material. The web is then cooled and pressed to a predetermined thickness to produce a core layer having a void content, for example, of between about 1 percent to about 95 percent. A film with a high viscosity layer and tie layer can then be laminated to the core layer, or added to the core layer prior to softening of the thermoplastic material, to bond the film to the core layer.

In certain configurations, the films described herein can be produced in numerous ways. For example, plastic extrusion techniques such as blown film extrusion, sheet/film extrusion, etc. can be used to provide the films. Where the thickness of the film is thin, blown film extrusion techniques may be desirable. Where thicker films are desired, sheet/film extrusion techniques may be desirable. In some instances, each layer of the film is produced separately and the film layers are then laminated or otherwise coupled to each other to provide a film comprising a high viscosity tie layer. The films can be expanded using air or other techniques, can be stretched or can otherwise be processed in a desired manner prior to coupling the film to the core layers. Large film rolls can be slit to form smaller rolls which can be used, for example, in a continuous process where the film is unrolled in the machine direction onto a formed core layer. After coupling of the film to the core layer, the article can be chopped or cut into desired lengths for packaging. If desired, one or more surfaces of the film can be subjected to chemical or physical treatment, e.g., corona treatment, vapor deposition to provide conductive films, addition of release agents, etc.

In certain embodiments, the articles described herein may comprise a film (with an integral tie layer) positioned between stacks of core layers. Referring to FIG. 6A, an article 600 comprises core layers 610, 630 separated by a film comprising a high viscosity tie layer 620. The film 620, for example, may be any one of the films described herein, e.g., may be any one of the films 120, 170, 300, 400 or 500. The core layers 610, 630 can be the same or can be different. In some instances, the core layers 610, 630 comprise at least one common material. In other instances, one of the core layers 610, 630 may be produced using a thermoplastic resin in particle form, and the other of the core layers 610, 630 can be produced using a thermoplastic resin in fiber form. The core layers 610, 630 can include the same or different types of reinforcing fibers and/or thermoplastic materials. In some instances, the film 620 may comprise at least one layer comprising a polyamide, at least another layer functional as a tie layer and at least a third layer comprising a high viscosity material. In other configurations, the film 620 can be configured as a 5-layer film with layers comprising a polyamide material adjacent to the core 610 and to the core 630, e.g., a linear or cyclic polyamide optionally without any caprolactam, material with the same or different polyamides being present in layers of the film 620 adjacent to the cores 610, 630. A central layer comprising a high viscosity, e.g., high viscosity polypropylene, can be sandwiched by tie layers on each side of the high viscosity layer.

Referring now to FIG. 6B, if desired an additional film 660 comprising a high viscosity layer and tie layer can be added to provide an article 650. In some instances, a third film (not shown) with a high viscosity layer and tie layer can be added to an opposite surface of the core layer 610 as well. The film 660 can be the same as the film 620 or can be different. In some instances, the films 620 and 660 are the same to simplify automated production of the article 650. In other configurations, even though the films 620 and 660 may be the same, one of the films 620, 660 can be placed in the machine direction and the other of the films 620, 660 can be placed in the cross direction. In some configurations of the article 650, the film 620 may not comprise a high viscosity layer or a tie layer or both, whereas the film 660 may comprise a high viscosity layer and tie layer. While not shown, one or more cover layers can also be present on the article 600 or the article 650. If desired, the film 660 may comprise an outer layer, e.g., a layer which can couple to a cover layer, which comprises a linear or cyclic polyamide or copolymer comprising a polyamide, e.g., a linear or cyclic polyamide optionally without any caprolactam.

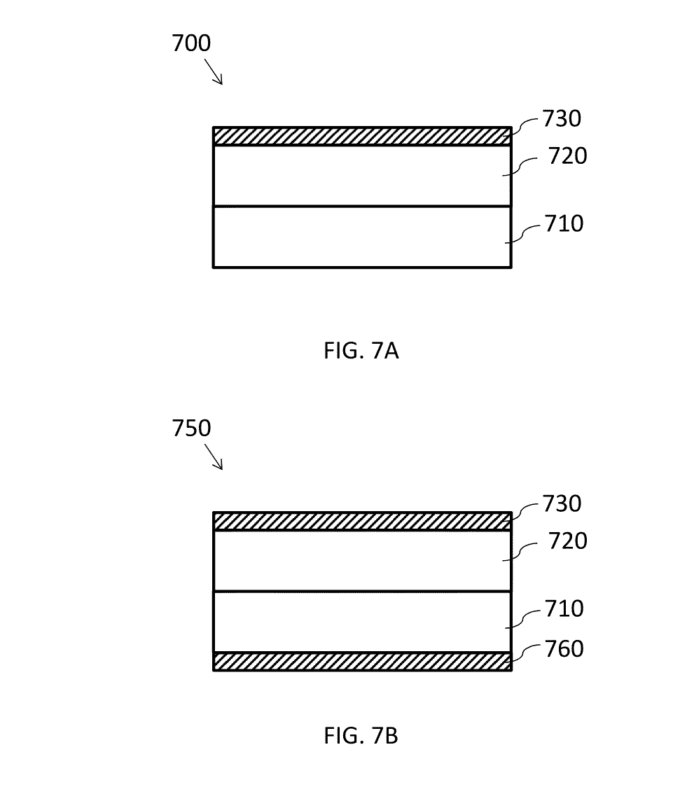

In certain instances, a composite article comprising core layer stacks may comprise about 2-10 core layers, more particularly about 2-8, 2-6 or 2-4 core layers. As noted in connection with FIGS. 6A and 6B, one or more films may separate the core layers of the stack. In certain instances, a film with a high viscosity layer and tie layer may only be present on an outer surface of the stack. Referring to FIG. 7A, an article 700 comprising core layers 710, 720 and a film 730 comprising a high viscosity layer and tie layer is shown. The core layers 710, 720 can be coupled by melting of the thermoplastic materials in the layers 710, 720 or can be coupled using an adhesive or other materials. In some instances, enough core layers are stacked to provide a desired thickness to the overall article 700, and then the film 730 is added to the top core layer of the stack. An additional layer, e.g., a cover layer or other layer can be coupled to the film 730 to provide a composite article comprising stacks of core layers. If desired, the film 730 may comprise an outer layer, e.g., a layer which can couple to a cover layer, which comprises a linear or cyclic polyamide or copolymer comprising a polyamide, e.g., a linear or cyclic polyamide optionally without any caprolactam.

In other configurations, an additional film comprising a high viscosity layer and tie layer can be added to an opposite surface of a core layer stack. Referring to FIG. 7B, an article 750 comprises core layers stacks 710, 720 and films 730, 760 each comprising an integral tie layer. Additional core layer stacks can be coupled to either of the films 730, 760, if desired. In an alternative configuration, 2-10 core layers stacks may be present between the tie layers 730, 760 to increase the overall thickness of the article 750 and/to provide an article with desired properties. In some configurations of the article 750, about 2-6 film layers may be present in the layered stack. Any two or more of the films may be the same or may be different. If desired, one or both of the films 730, 760 may comprise an outer layer, e.g., a layer which can couple to a cover layer, which comprises a linear or cyclic polyamide or copolymer comprising a polyamide, e.g., a linear or cyclic polyamide optionally without any caprolactam.

In certain configurations, where a specific basis weight of the core layer is desired, a single core layer can be produced with the specific basis weight or multiple core layers each of a lesser basis weight can be combined to provide the specific basis weight. In some instances, a film can be present between each core layer, whereas in other instances, a film, e.g., a film comprising a high viscosity layer and tie layer, may only be present on an outer surface or surfaces of the core stack. An adhesive layer can be present, if desired, between core layer stacks to facilitate coupling of the core layers to each other.

In certain embodiments, the films can be added to the core layers of the core layer stacks subsequent to formation of the core layers, e.g., may be laminated, bonded or otherwise attached to the core layer in some manner. Without wishing to be bound by any particular scientific theory, during processing, the film can bond to the polymer core by fusion with the polymer component of the core, optionally through the use of an adhesive(s), to provide sufficient bond strength between the core and the films in order to prevent delamination during thermoforming. In some examples, the adhesive may be in the form of a layer, such as an adhesive film, coating, or other type of layer applied to the core and/or the surface layers, whereas in other examples, adhesive may be disposed intermittently between the core layer and the film. If desired, scattered particles between the core and the surface layers can be present, and, the particles may, but are not required to, provide adhesion (or additional adhesion) between the core and the film.

In certain embodiments, the composite articles can be produced using numerous methods. For example, the composite may generally be prepared in various forms, such as sheets or films, as layered materials on pre-formed substrates, or in other more rigid forms depending on the particular application desired. For certain applications, the composite can be provided in sheet form and may optionally include, in addition to the films, one or more additional layers on one or both surfaces of such sheet. In one illustration, such additional cover layer may be another film, a non-woven scrim, a veil, a woven fabric, or combinations thereof. If desired, the additional layers may be air permeable and can substantially stretch and spread with the composite article during thermoforming and/or molding operations. In addition, such layers may be adhesive, such as a thermoplastic material (e.g., an ethylene acrylic acid copolymer or other such polymers) applied to the surface of the fiber-containing thermoplastic material. Generally, the areal density of the composite article, particularly when in sheet form, varies from about 150 gsm to about 4000 gsm, more particularly about 150 gsm to about 3000 gsm, e.g., about 200 gsm to about 800 gsm, or about 300 gsm to about 700 gsm or about 300 gsm to about 600 gsm.

In other instances, the film can be formed and placed during formation of the core layer. For example, a film can be extruded onto a partially formed core layer that is still soft. For example, as the materials of the core layer are laid down on a web and still remain soft, a film can be extruded and placed on top of the soft core layer. Hardening of the core layer and/or passing of the film plus core layer through one or more nips or rollers can act to couple the film to the core layer.

In certain embodiments, the composite articles described herein can be used to provide intermediate and final form articles, including construction articles or articles for use in automotive and other applications including, but not limited to, a headliner, a door module, an instrument panel topper, a body and hood panels, side wall panels such as for recreational vehicles, cargo liners, front and/or rear pillar trim, a sunshade, and the like. Other such articles will be apparent to the skilled artisan, given the benefit of this disclosure. The composite articles can be molded into various articles using numerous methods including, but not limited to, pressure forming, thermal forming, thermal stamping, vacuum forming, compression forming, and autoclaving. Illustrative methods are described, for example, in U.S. Pat. Nos. 6,923,494 and 5,601,679, and in DuBois and Pribble's “Plastics Mold Engineering Handbook”, Fifth Edition, 1995, pages 468 to 498 and elsewhere.

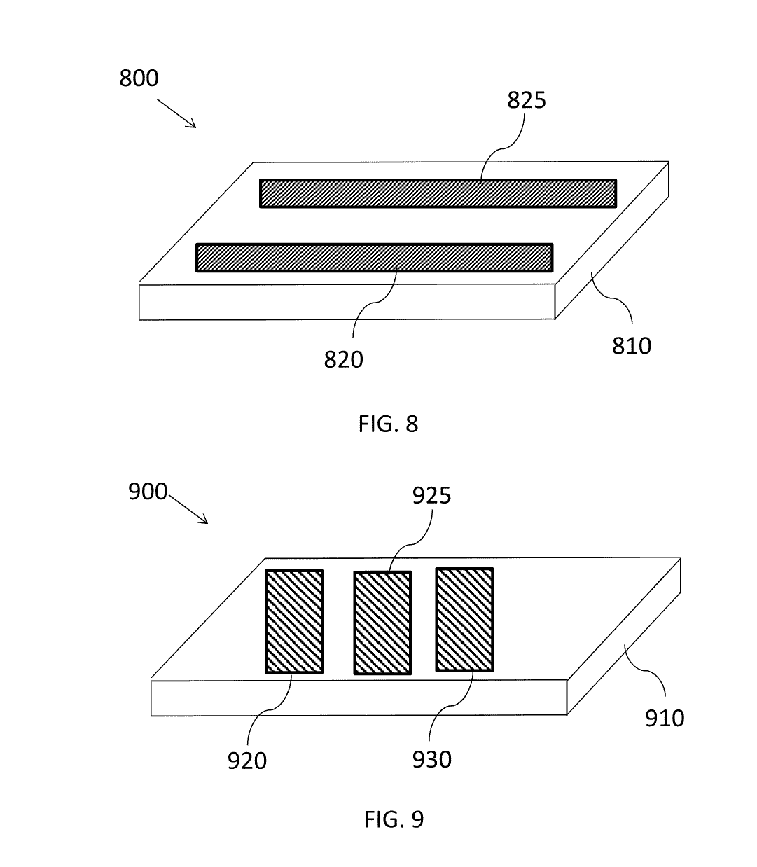

In certain examples, the films described herein can be disposed on an entire surface of the core layer, can be disposed intermittently on the surface or can be disposed in strips or patches. Illustrations showing perspective views of a composite with skin materials disposed in different manners are shown in FIGS. 8-11. Referring to FIG. 8, a composite article 800 comprises a core layer 810 and strips 820, 825 of a film disposed generally along the long-axis direction (e.g., machine direction) of the composite article 800. While not wishing to be bound by any particular scientific theory, it may be desirable to dispose the film in areas where additional reinforcement is needed. In some embodiments, one or more film patches can be disposed on an existing film to provide additional or enhanced bonding at those areas, e.g., strips can be applied along the edges of the core layer to enhance resistance to peeling at the edges. The exact dimensions, width and composition of the strips 820 and 825 can vary and typically the strips can be produced from the same materials and using the same processes as those used to produce the films described herein. In some embodiments, at least one of the strips 820 and 825 can be selected to comprise a film comprising a high viscosity layer and tie layer or both strips 820, 825 can comprise a film comprising a high viscosity layer and a tie layer. The composition and dimensions of the strips 820 and 825 need not be the same. In addition, areas of each of the strips 820 and 825 may include different compositions, e.g., different tie layer materials or tie layers of a different viscosities, different non-polar film components, etc. In other configurations, the entire planar surface of the core can include a first surface layer (which may or may not be a film comprising a high viscosity tie layer), and film strips, such as those shown in FIG. 8, can be disposed on a surface opposite the first surface layer. While FIG. 8 shows a composite article 800 comprising two strips 820 and 825, only a single film strip or a plurality of strips can also be used, e.g., three, four, five, six or more separate strips can be present. In some embodiments, the strips can be applied by an end-user prior to forming of the composite article into a desired structure or shape, e.g., into an automotive interior part, or can be pre-applied to a first surface layer prior to applying the first surface layer to the core layer. As noted herein in connection with other films, the one or both of the film strips 820, 825 may comprise, if desired, an outer layer, e.g., a layer which can couple to a cover layer, which comprises a linear or cyclic polyamide or copolymer comprising a polyamide, e.g., a linear or cyclic polyamide optionally without any caprolactam.

Referring now to FIG. 9, a composite article 900 is shown comprising a core layer 910 with a plurality of film strips 920, 925 and 930 disposed on the core layer 910 in a direction generally orthogonal to the long axis direction (e.g., cross direction) of the composite article 900. As described herein, it may be desirable to dispose the film strips in areas of the composite article where additional bonding is desirable, e.g., at the edges. The exact dimensions, width and composition of the strips 920, 925 and 930 can vary and typically the strips can be produced from the same film materials and using the same processes as those used to produce the films comprising the high viscosity tie layers described herein. In some embodiments, at least one of the strips 920, 925 and 930 comprise a film with a high viscosity layer and a tie layer. In other embodiments, at least two of the strips 920, 925 and 930 comprise a film with a high viscosity layer and a tie layer. In certain examples, all of the strips 920, 925 and 930 comprise a high viscosity layer and a tie layer. The strips 920, 925 and 930 can also include a reinforcing material which may be the same or may be different in the various strips 920, 925 and 930. In certain examples, at least one of the strips 920, 925 and 930 can be selected to provide a basis weight of at least 10 gsm for the strip. In certain examples, at least two of the strips 920, 925 and 930 can be selected to comprise a basis weight of at least 10 gsm for each strip. In other examples, each of the strips 920, 925 and 930 can be selected to comprise a basis weight of at least 10 gsm for each stip. If desired, areas of each of the strips 920, 925 and 930 may include different compositions, e.g., different tie layers, tie layers of different viscosities, different non-polar film components, etc. In other configurations, the entire planar surface of the core layer 910 can include a first surface layer (which may be a film comprising a high viscosity tie layer), and strips, such as those shown in FIG. 9, can be disposed on the first surface layer. While FIG. 9 shows a composite 900 comprising three strips 920, 925 and 930, only a single film strip or more than three strips can be used, e.g., four, five, six or more separate strips can be present. In some embodiments, the strips can be applied by an end-user prior to forming of the composite into a desired structure or shape, e.g., into an automotive interior part, or can be pre-applied to a first surface layer prior to applying the first surface layer to the core layer. As noted herein in connection with other films, one or more of the film strips 920, 925 and 830 may comprise, if desired, an outer layer, e.g., a layer which can couple to a cover layer, which comprises a linear or cyclic polyamide or copolymer comprising a polyamide, e.g., a linear or cyclic polyamide optionally without any caprolactam.

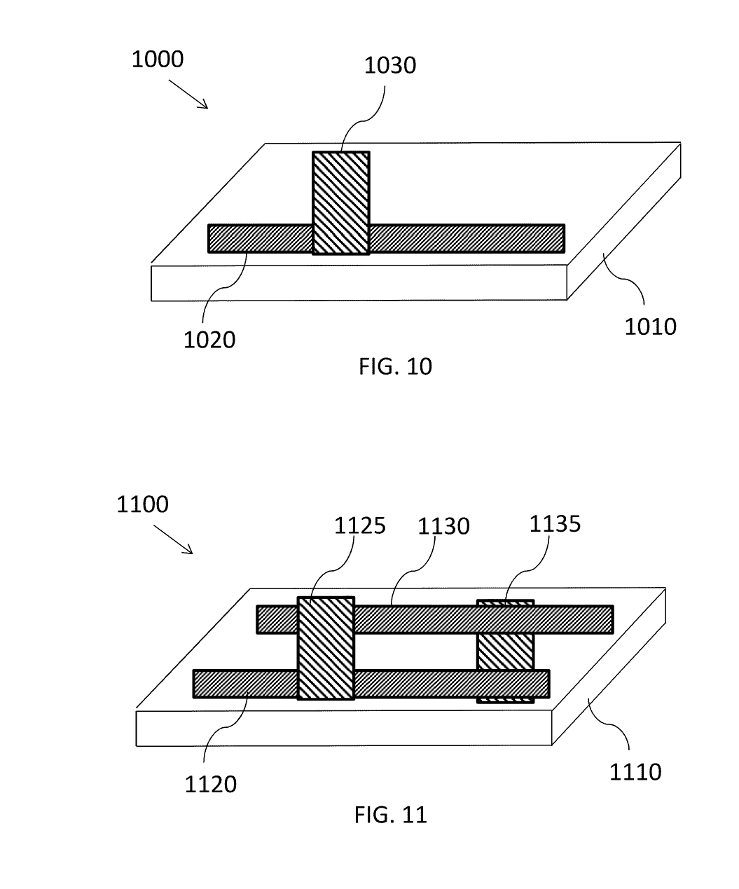

In certain embodiments where film strips are disposed on a core material, more than a single film strip can be provided, and the different film strips can be positioned differently on the composite. Referring to FIG. 10, a composite article 1000 comprises a core layer 1010, a first film strip 1020 disposed on the core layer 110, and a second film strip 1030 disposed on the first film strip 1020. The second film strip 1030 is disposed orthogonal to the first film strip 1020. One or both of the film strips 1020, 1030 may comprise a high viscosity layer and a tie layer. In some instances, the film strip 1030 comprises a high viscosity layer and a tie layer, and the film 1020 does not comprise a high viscosity layer (but may or may not comprise a tie layer). In certain instances, the angle between the strips 1020 and 1030 need not be ninety degrees, e.g., it can be less than ninety degrees or more than ninety degrees. The embodiment shown in FIG. 10 comprises the first strip 1020 disposed immediately adjacent to the core layer 1010, but in other examples, the strip 1030 can be disposed immediately adjacent to the core layer 1010, and the strip 1020 can be disposed on the strip 1030. As described herein, it may be desirable to dispose the film strips in areas of the composite to provide additional or enhanced bonding, e.g., at the edges. The exact dimensions, width and composition of the strips 1020 and 1030 can vary and typically the strips can be produced from the same materials and using the same processes as those used to produce the films described herein. In some examples, at least one of the strips 1020, 1030 comprises a basis weight of at least 10 gsm. In certain examples, each of the strips 1020 and 1030 comprises a basis weight of at least 10 gsm. The composition and dimensions of the strips 1020 and 1030 need not be the same. In addition, areas of each of the strips 1020 and 1030 may include different compositions, e.g., different tie layers, different high viscosity materials, tie layers of different viscosities, different non-polar film components, etc. In other configurations, the entire planar surface of the core layer 1010 can include a first surface layer (which may or may not be a film comprising a high viscosity tie layer), and film strips, such as those shown in FIG. 10, can be disposed on the first surface layer. While FIG. 10 shows a composite article 1000 comprising two film strips 1020 and 1030, only a single film strip or a plurality of strips can also be used, e.g., three, four, five, six or more separate strips can be present. In some embodiments, the film strips can be applied by an end-user prior to forming of the composite into a desired structure or shape, e.g., into an automotive interior part, or can be pre-applied to a first surface layer prior to applying the first surface layer to the core layer. As noted herein in connection with other films, one or both of the film strips 1020, 1030 may comprise, if desired, an outer layer, e.g., a layer which can couple to a cover layer, which comprises a linear or cyclic polyamide or copolymer comprising a polyamide, e.g., a linear or cyclic polyamide optionally without any caprolactam. In some instances, only the outer layer of the outermost strip 1030 may comprise a linear or cyclic polyamide or copolymer comprising a polyamide, e.g., a linear or cyclic polyamide optionally without any caprolactam.

In certain examples where two or more strips are disposed on a core, different areas of the strips may be disposed in a different manner. Referring to FIG. 11, a composite article 1100 comprises a core layer 1110 with film strips 1120, 1125, 1130 and 1135 disposed on the core layer 1110. The strip 1135 is positioned in direct contact with the core layer 1110 and under the strips 1120 and 1130, whereas the strip 1125 is positioned on top of the strips 1120 and 1130. In a different configuration, the strip 1135 could be positioned under the strip 1130 but on top of the strip 1120, for example. As described herein, it may be desirable to dispose the film strips in areas of the core layer where enhanced bonding is desired. The exact dimensions, width and composition of the strips 1120, 1125, 1130 and 1135 can vary and typically the film strips can be produced from the same materials and using the same processes as those used to produce the films described herein. In some embodiments, at least one of the strips 1120, 1125, 1130 and 1135 can include a high viscosity layer and a tie layer. In other embodiments, at least two of the strips 1120, 1125, 1130 and 1135 can include a high viscosity layer and a tie layer. In some examples, at least three of the strips 1120, 1125, 1130 and 1135 can include a high viscosity layer and a tie layer. In certain embodiments, all of the strips 1120, 1125, 1130 and 1135 can include a high viscosity layer and a tie layer. In certain embodiments, at least one of the strips 1120, 1125, 1130 and 1135 can have a basis weight of at least 10 gsm. In other embodiments, at least two of the strips 1120, 1125, 1130 and 1135 can have a basis weight of at least 10 gsm. In additional embodiments, at least three of the strips 1120, 1125, 1130 and 1135 can have a basis weight of at least 10 gsm. In certain examples, each of the strips 1120, 1125, 1130 and 1135 can have a basis weight of at least 10 gsm. The composition and dimensions of the strips 1120, 1125, 1130 and 1135 need not be the same. In addition, areas of each of the strips 1120, 1125, 1130 and 1135 may include different compositions, e.g., different tie layers, tie layers of different viscosities, different non-polar film components, etc. In other configurations, the entire planar surface of the core layer 1110 can include a first surface layer (which may or may not be a film comprising a high viscosity tie layer), and strips, such as those shown in FIG. 11, can be disposed on the first surface layer. While FIG. 11 shows a composite 1100 comprising four strips 1120, 1125, 1130 and 1135, only a single strip of more than four strips can also be used, e.g., five, six, seven, eight or more separate strips can be present. In some embodiments, the strips can be applied by an end-user prior to forming of the composite article into a desired structure or shape, e.g., into an automotive interior part, or can be pre-applied to a first surface layer prior to applying the first surface layer to the core layer. As noted herein in connection with other films, one or more of the film strips 1120-1135 may comprise, if desired, an outer layer, e.g., a layer which can couple to a cover layer, which comprises a linear or cyclic polyamide or copolymer comprising a polyamide, e.g., a linear or cyclic polyamide optionally without any caprolactam. In some instances, only the outer layer of the outermost strip 1125 may comprise a linear or cyclic polyamide or copolymer comprising a polyamide, e.g., a linear or cyclic polyamide optionally without any caprolactam.

In other configurations, a cover layer or a decorative layer can be applied to a second surface layer of the article by any known technique, for example, lamination, adhesive bonding, and the like. The decorative layer may be formed, e.g., from a thermoplastic film of polyvinyl chloride, polyolefins, thermoplastic polyesters, thermoplastic elastomers, or the like. The decorative layer may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. A decorative layer may also be made using spunbond, thermal bonded, spun lace, melt-blown, wet-laid, and/or dry-laid processes.

Certain specific examples are described below to illustrate further some of the novel aspects of the technology described herein.

### Example 1

Analytical tests were performed to evaluate certain physical properties of films. Three films were tested including (1) a bilayer film with a copolyamide (CoPA) layer and a polypropylene (PP) layer (Film 1), (2) a Xiro 45.311 60 gsm film (Film 2) and a (3) Xiro 45.311 80 gsm film (Film 3). The basis weight of Film 1 was determined using a puck of about 99 mm in diameter with 5 specimens per test. The samples were conditioned for 24 hours at 72 degrees Fahrenheit and 50% relative humidity. The weight of each puck is measured before and after addition of the film.

Differential scanning calorimetry (DSC) measurements were also performed. In the DSC measurement, a two heating-cooling cycle measurement was used, and the hating/cooling rate was 10 degrees Celsius per minute.

The basis weight of Film 1 was determined to be about 58.7 gsm. About 50% of the basis weight was from the copolyamide layer and tie layer and the remaining 50% of the basis weight was from the polypropylene layer. The basis weight of Films 2 and 3 were not measured but were specified as noted above by the supplier to be about 60 gsm (Film 2) and 80 gsm (Film 3).

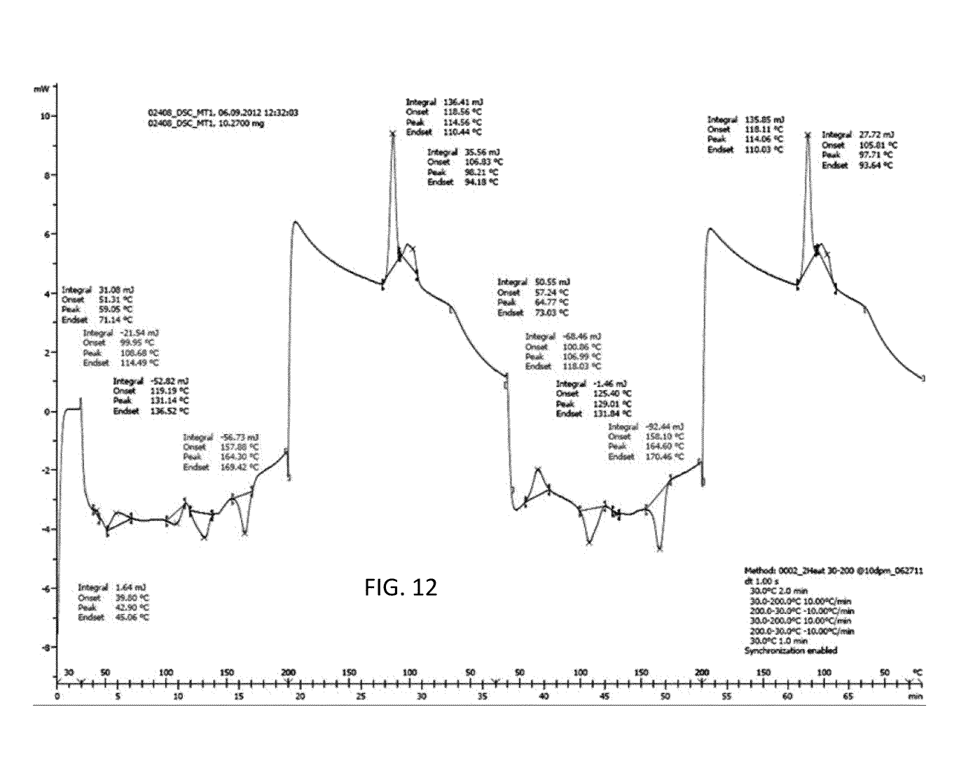

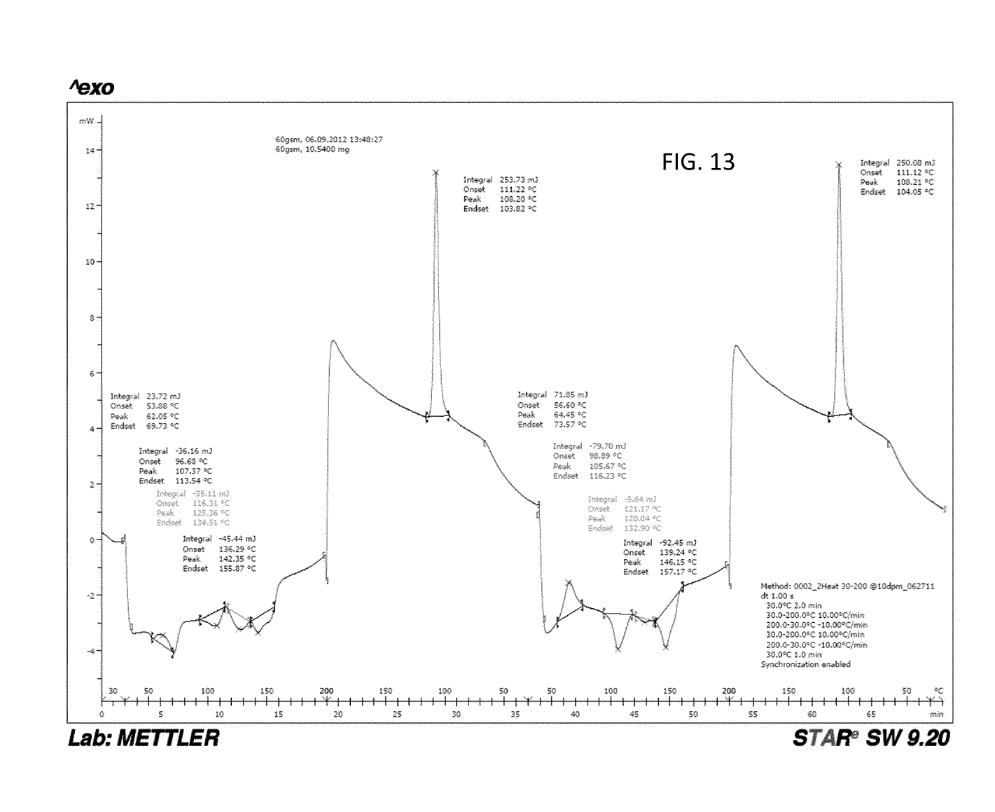

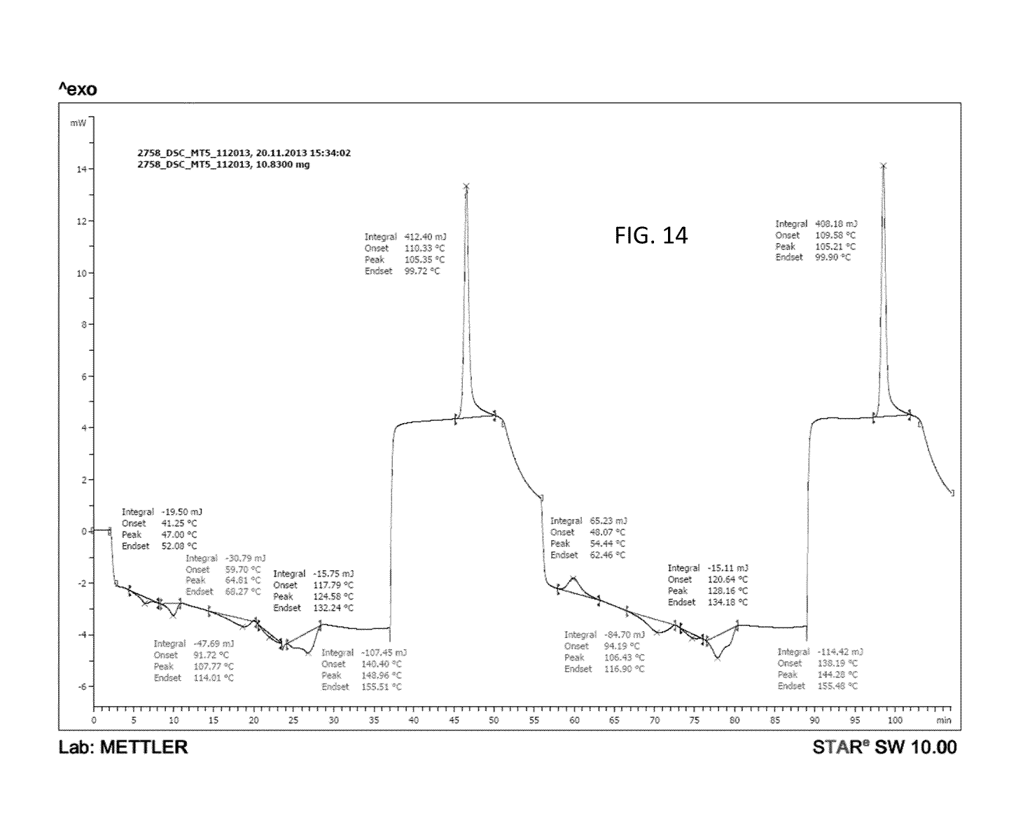

DSC measurements were performed as evidence of film components and performance. The peaks listed in Table 1 below are observed during the second heating cycle. The DSC curves are shown in FIG. 12-14. FIG. 12 shows the DSC curve for Film 1, FIG. 13 shows the DSC curve for Film 2 and FIG. 14 shows the DSC curve for Film 3.

TABLE 1

| | CoPA | CoPA | | |
|---|---|---|---|---|
| Film # | Recrystallization | Melting | PP Peak | |
| Film 1 | 65 deg. C. | 107 deg. C. | 129 deg. C. | 165 deg. C. |
| Film 2 | 64 deg. C. | 106 deg. C. | 128 deg. C. | 146 deg. C. |
| Film 3 | 66 deg. C. | 106 deg. C. | 130 deg. C. | 143 deg. C. |

The DSC measurements showed similar thermal characteristics for the copolyamide peaks, but differences were observed for the polypropylene peaks.

### Example 2

Peel strength measurements of composite articles including a thermoplastic core and the three films from Example 1 were also measured to evaluate adhesion performance. A polyurethane foam layer was laminated to the thermoplastic core/film composite.

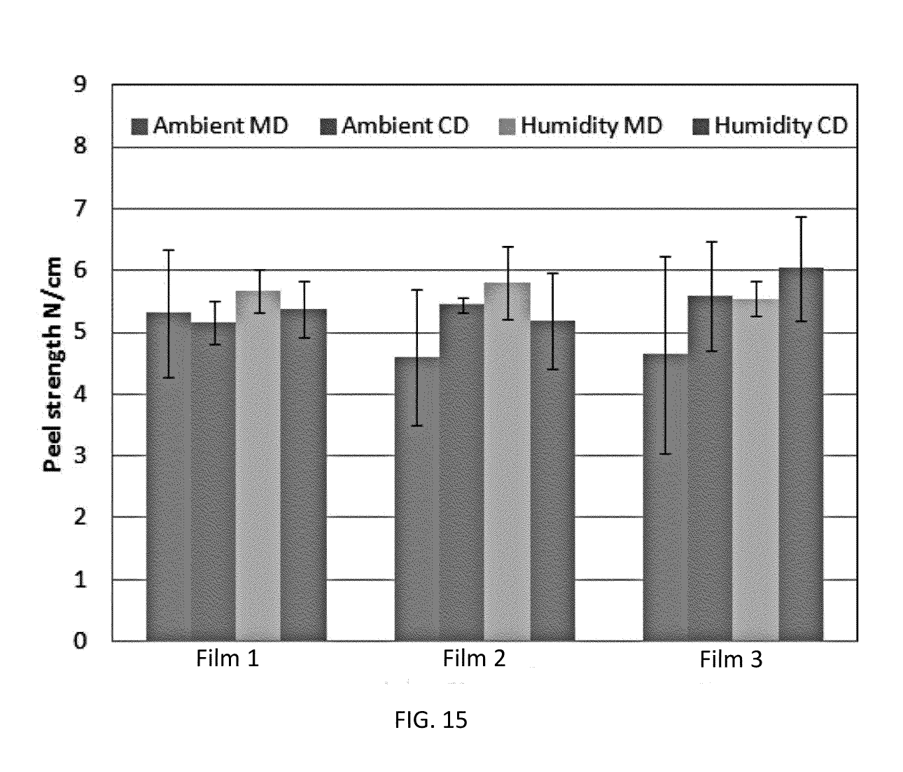

In a 180 degree peel test, specimens of 150 mm by 25 mm were produced and placed in a humidity chamber at 35 degrees Celsius and 95% humidity for 16 hours prior to performing the 180 degree peel test. Specimens were produced in the lab by laminating a core layer to the film and then to the foam cover layer. The core layer had a basis weight of about 800 gsm and comprised about 43.7 weight percent glass fibers, about 2.8 weight percent lofting agent with the balance of the core (about 53.5 weight percent) including polypropylene. The specimens had a final thickness of about 3.5 mm. The results of the testing are shown in FIG. 15. The performance of Film 1 is comparable to Films 2 and 3, even though Film 1 had a lower basis weight than Film 3. Ambient conditions refer to room temperature (about 25 degrees Celsius) and atmospheric pressure and MD refers to machine direction and CD refers to cross direction. From left to right for each film, the bar graphs represent, ambient MD, ambient CD, humidity MD and humidity CD.

### Example 3

Adhesion performance of the films was further tested by varying the thickness and processing conditions of the articles. The different testing conditions are listed in Table 2.

TABLE 2

| Condition | Temperature | Oven Time | Core molding thickness |
|---|---|---|---|
| 1 | 204 deg. C. | 2.5 min. | 3.5 mm |
| 2 | 204 deg. C. | 2.5 min. | 3.0 mm |
| 3 | 220 deg. C. | 2.0 min. | 3.5 mm |
| 4 | 220 deg. C. | 2.0 min. | 3.0 mm |

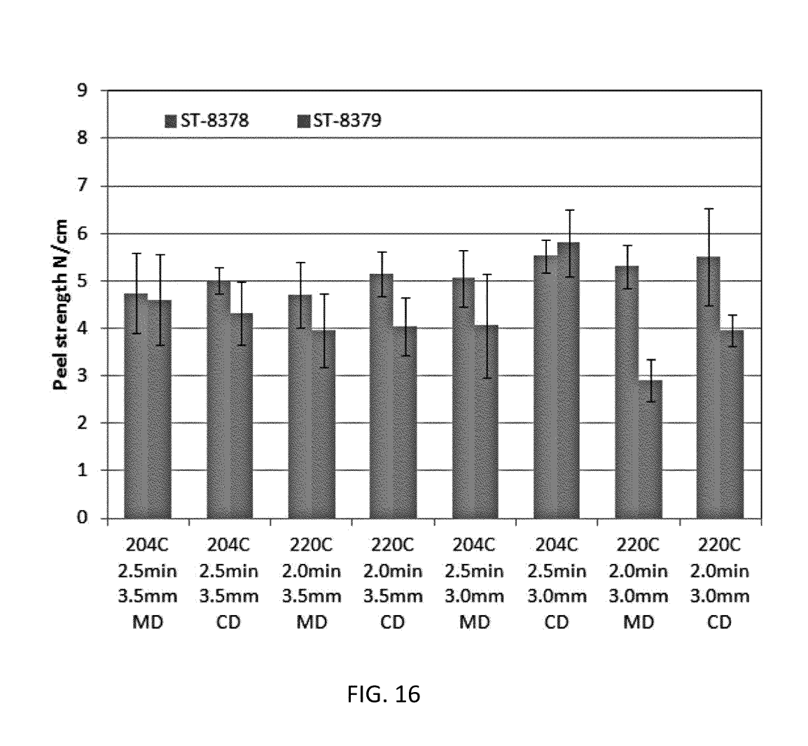

The results of the testing conditions are shown in FIG. 16. The experimental article (ST-8378) with Film 1 shows comparable performance to a control article (ST-8379) with Film 3. For each grouping in the bar graph in FIG. 16, the experimental material appears on the left and the control material appears on the right.

### Example 4

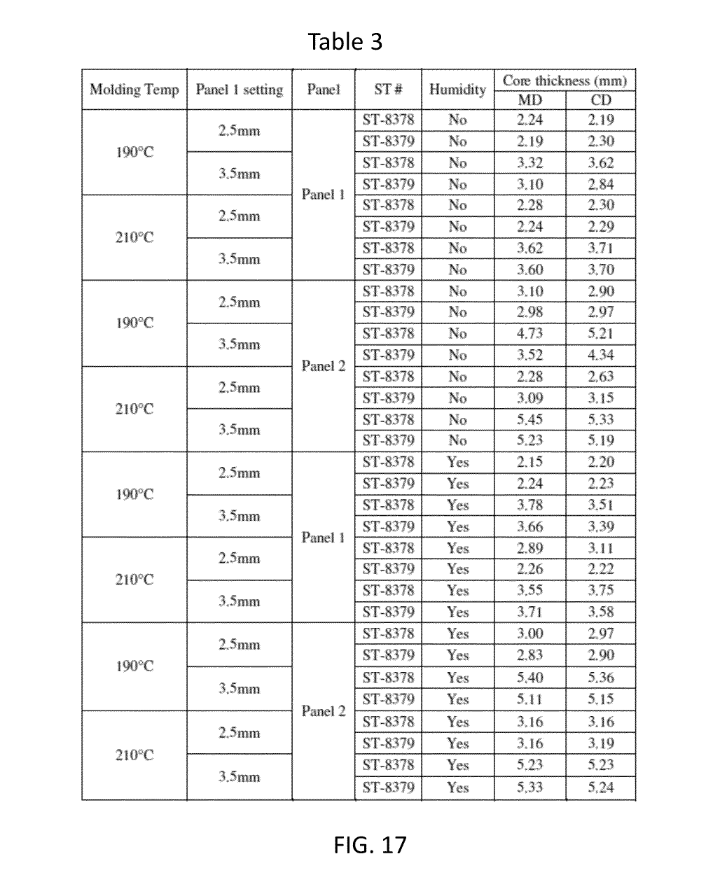

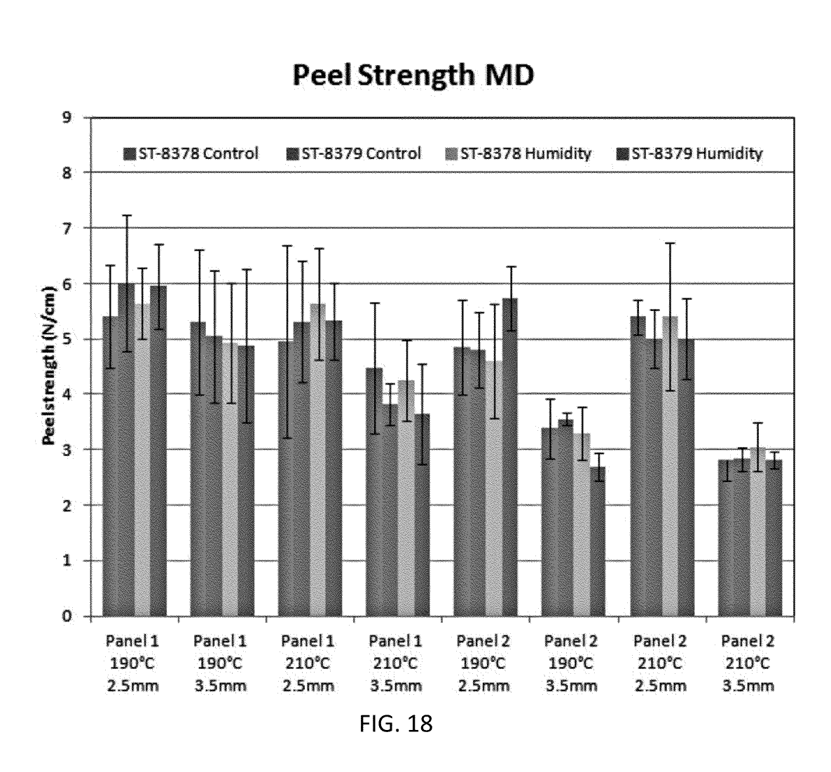

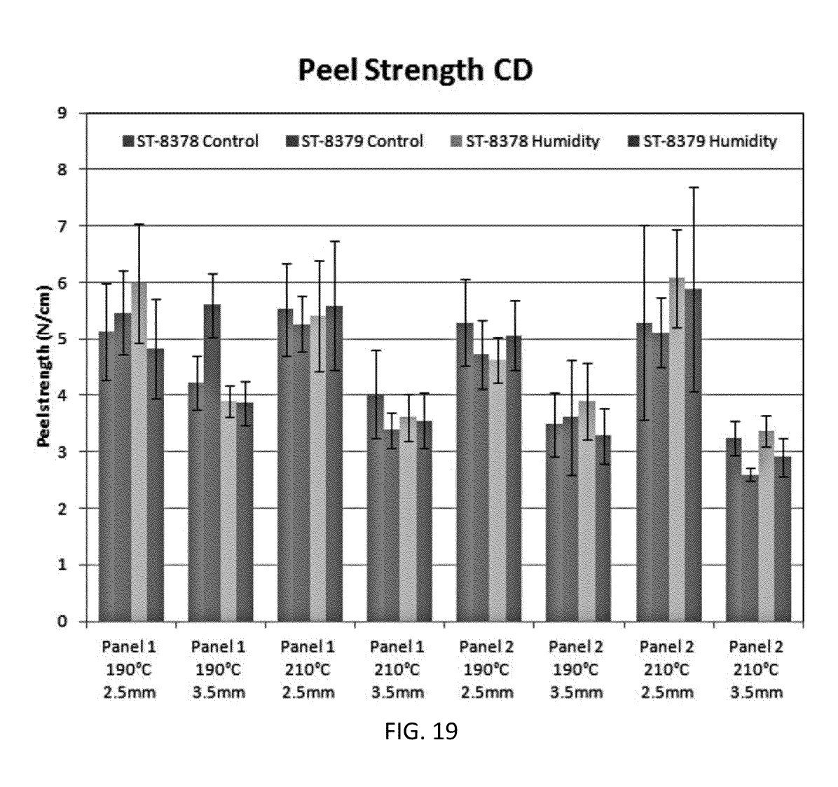

Various parts were molded into mini headliners. The molding temperature was set at 190 degrees C. and 210 degrees C. The experimental article (ST-8378) and the control article (ST-8379) were processed in an identical manner. No significant differences were observed during the molding process. The gap of panel 1 was controlled during molding. Table 3 in FIG. 17 summarizes the actual substrate molding thickness of the specimens under different molding conditions. No changes in color were observed during the processing temperatures in this Example. FIGS. 18 and 19 show the peak adhesion strength of all the parts molded in the machine directions and cross directions. For each bar graph grouping, the left to right bars represent ST-8378 (ambient conditions), ST-8379 (ambient conditions), ST-8378 (humidified conditions) and ST-8739 (humidified conditions). No significant performance differences were observed at the two different processing temperatures. Adhesion performance generally decreased as molding thickness increases in both the control and experimental samples.

### Example 5

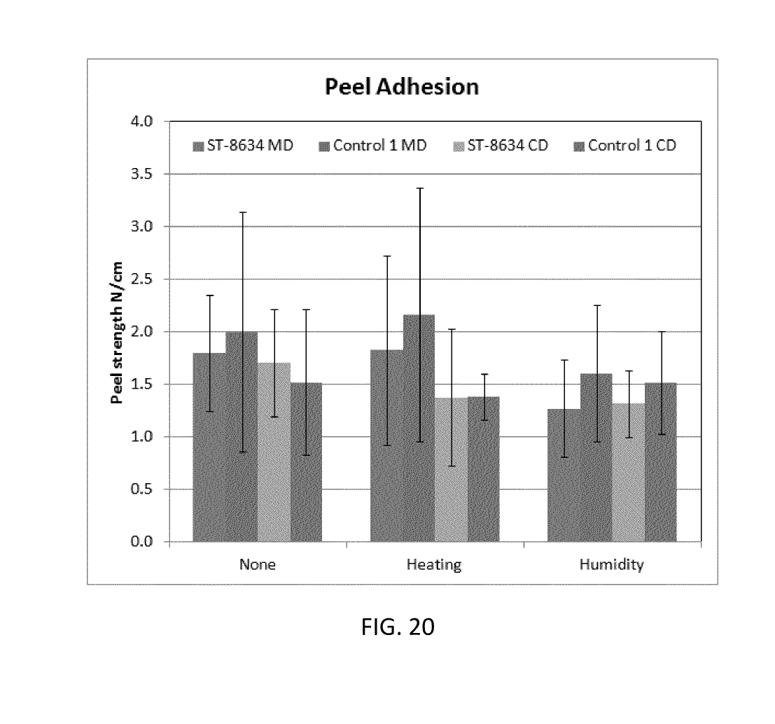

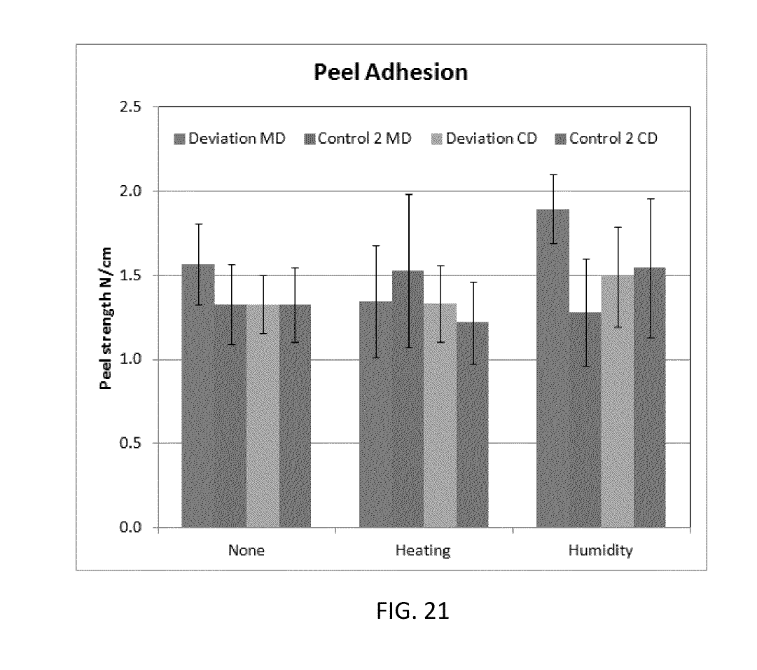

Film 1 was evaluated further by laminating the film to a core layer similar to that described in Example 2. A polyurethane layer was laminated to the film to provide a headliner. Headliner pieces were evaluated under ambient conditions (about 25 degrees C.), using heat (90 degrees C. for 24 hours, followed by 1 hour at ambient temperature) and under humidified conditions (50 degrees C. and 90% humidity for 24 hours, followed by 1 hour at ambient temperature). The specimens with Film 1 are referred to as ST-8634 and are compared to headliners produced using Film 2 (referred to as Control 1, which had a core including a basis weight of 800 gsm). The results of the 180 degree peel test are shown in FIG. 20. From left to right in each bar grouping, the bars represent ST-8634 MD, Control 1 MD, ST-8634 CD and Control 1 CD. Similar tests were performed on deviation (Film 1 as mentioned in Example 1) and productions runs (Film 2 as mentioned in Example 1). The peel testing results of the deviation and production runs are shown in FIG. 21. From left to right in each bar grouping, the bars represent Deviation MD, Production MD, Deviation CD and Production CD.

### Example 6

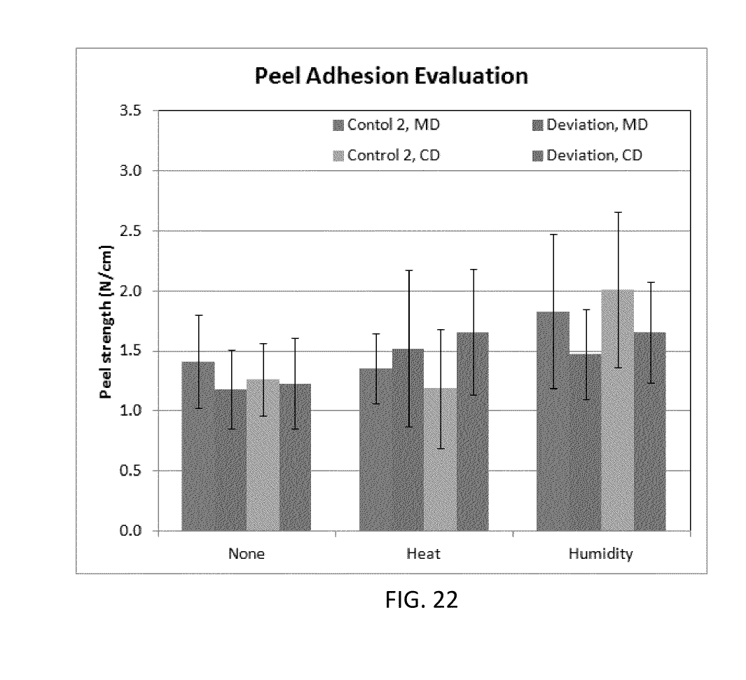

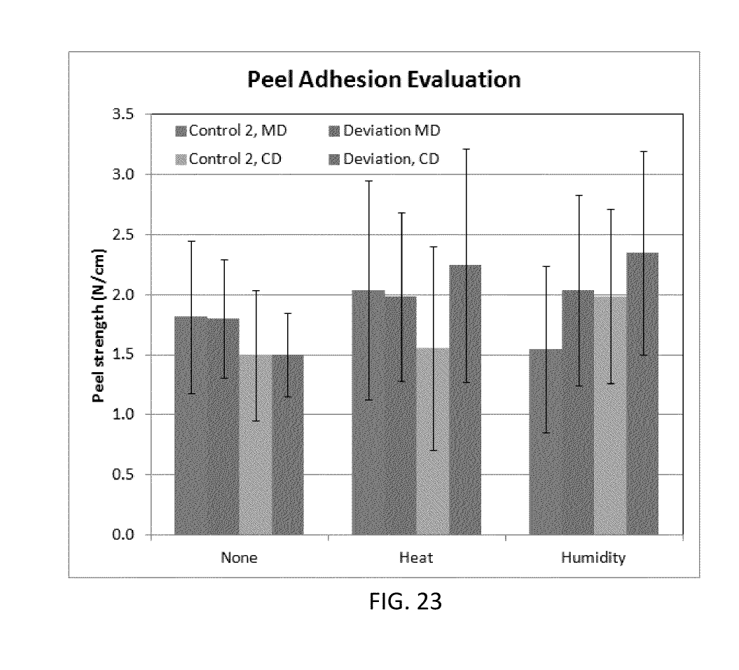

Evaluations similar to those of Example 5 were performed using plaques cut from molded headliners of Control 2 sample, which also uses Film 2 mentioned in example 1. The evaluation was conducted on both 4-pallet deviation run and 2-pallet deviation run. FIG. 22 shows the peel strength of the 4-pallet deviation (core material has a basis weight of about 700 gsm and the deviation run used Film 1 as mentioned in Example 1) run specimens cut from molded headliners following the methodology described in Example 5. FIG. 23 shows the peel strength of the 2-pallet deviation run specimens cut from molded headliners following the methodology described in Example 5. From left to right in each bar grouping, the bars represent Control 2 MD, Deviation MD, Control 2 CD and Deviation CD.

### Example 7

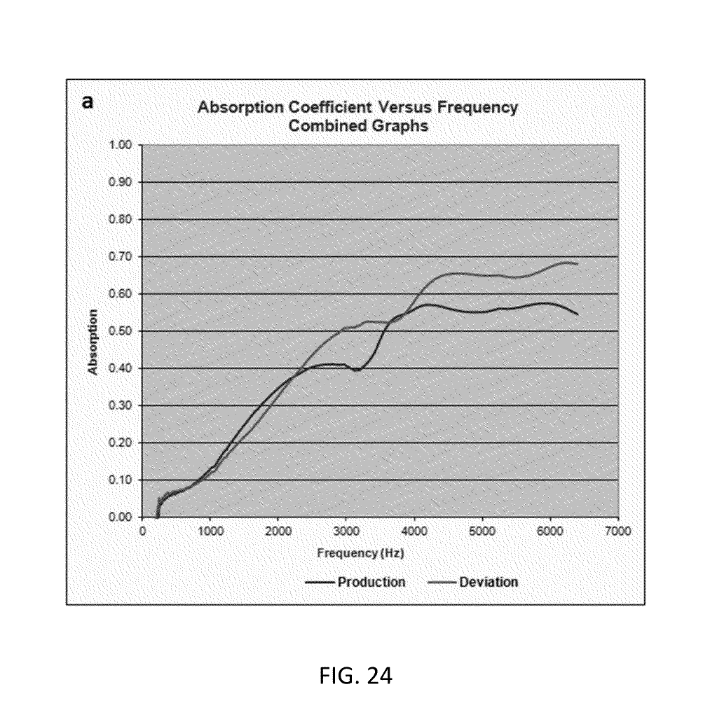

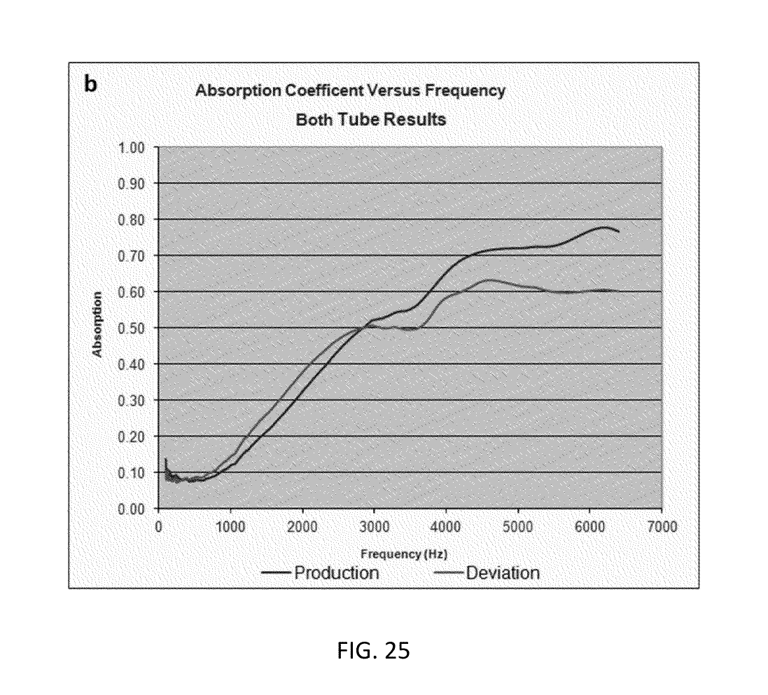

Additional evaluation of both Control 2 and deviation materials for acoustic performance was performed. Flat panels cut from headliners were measured. Slits in the films were present in the panels. The results are shown in FIG. 24 for the 4-pallet deviation and in FIG. 25 for the 2-pallet deviation.

The results from the various examples and graphs described above are consistent with a film with an integral viscosity tie layer providing comparable performance to heavier films that lack an integral tie layer.

### Example 8

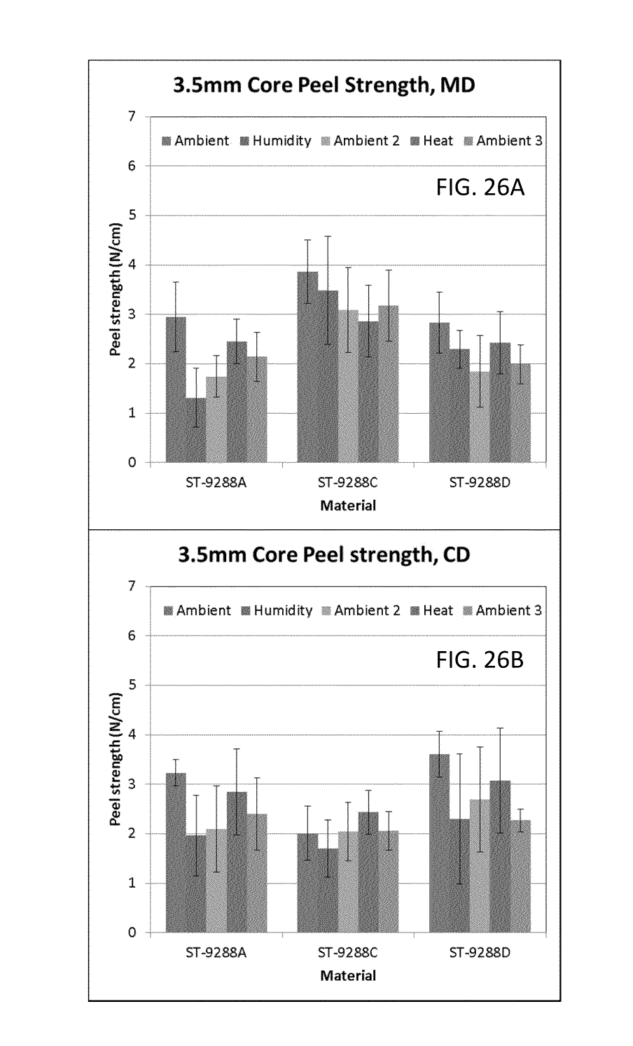

FIGS. 26A and 26B show the peel strength (machine direction for FIG. 26A and cross direction for FIG. 26B) of three constructs. From left to right in each of the bar groupings, the bars represent, ambient, humidity, ambient 2, heat and ambient 3. As shown in the table of FIG. 31, the ST-9288A construct included an 80 gsm film without a high viscosity tie layer, 30 gsm adhesive and 50 gsm polypropylene (PP). The ST-9288C construct included a 70 gsm film with a high viscosity tie layer, 30 gsm adhesive and 40 gsm PP. The ST-9288D construct included an 80 gsm film with a high viscosity tie layer, 30 gsm adhesive and 50 gsm PP. The core of each of the constructs was 3.5 mm thick. The film basis weight in this example is higher than in Film 1 tested in the prior examples. The sheets were lab assembled with a foam type cover material and measured 150 mm by 25 mm. The loading rate was 300 mm/min.

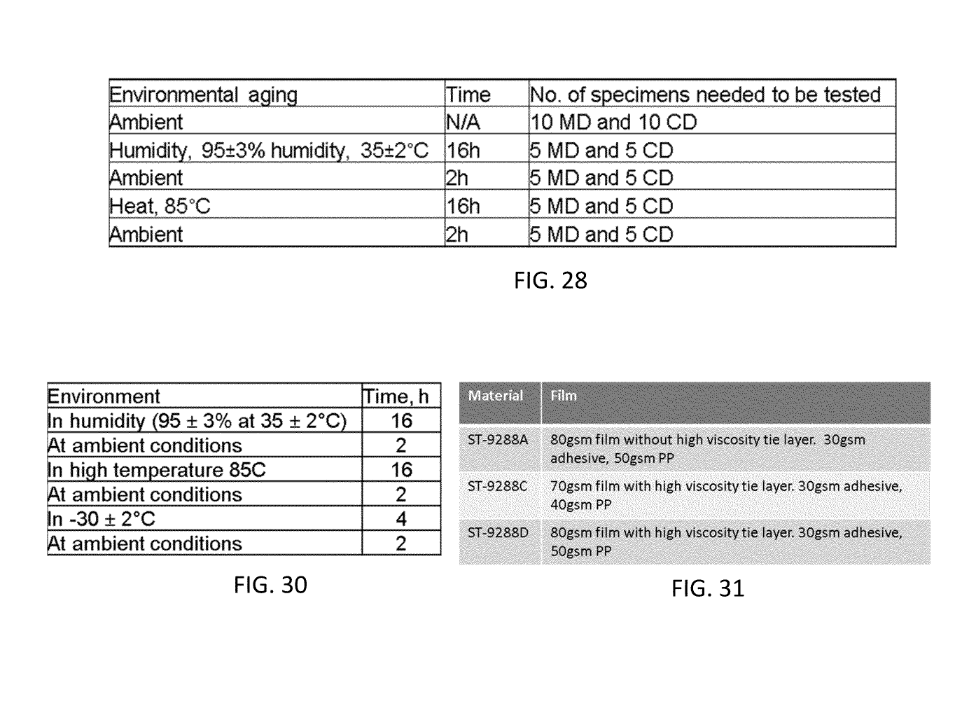

The various testing conditions are shown in the table of FIG. 28. The machine direction peel strength increased when the high viscosity tie layer was present (ST-9288C and ST-9288D). The cross direction peel strength increased when more PP was present (ST-9288D).

### Example 9

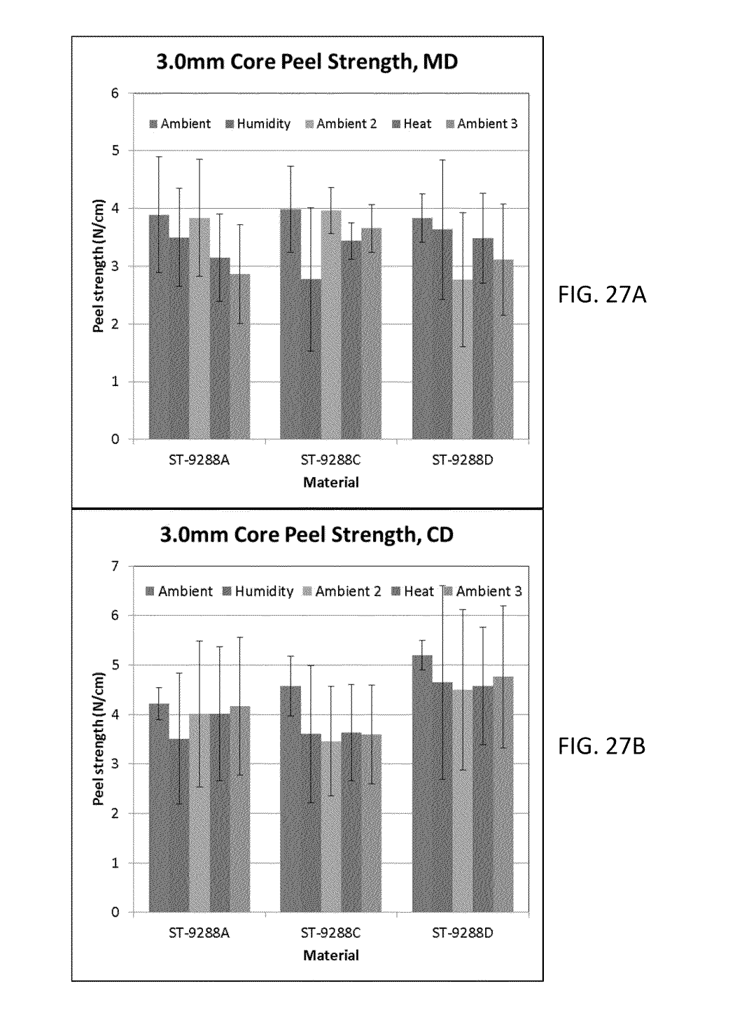

Additional test samples similar to the ones of Example 8 were tested, except the core thickness used was 3.0 mm instead of 3.5 mm. The results are shown in FIGS. 27A and 27B. From left to right in each of the bar groupings, the bars represent, ambient, humidity, ambient 2, heat and ambient 3.

In comparing the machine direction peel strengths of Example 8 and Example 9, the machine direction peel strength generally increased when a less thick core was used. Similarly, the less thick core results in an increase in cross-direction peel strength as well. However, when overall molding thickness increases (e.g., the 3.5 mm core provides a thicker construct than the 3.0 mm core), the presence of a high viscosity tie layer provides enhanced peel strength at a similar density. In general, where the density of the core layer is constant but the thickness increases, it is expected that peel strength would decrease because the material is less dense, e.g., less material is present at the surface to bond to. Where a high viscosity tie layer is present, this expected decrease in peel strength can be reduced, offset or avoided.

These results are consistent with the high viscosity tie layer providing increased peel strength even where the overall article has an overall increased thickness (at a substantially constant basis weight) for its core layer.

### Example 10

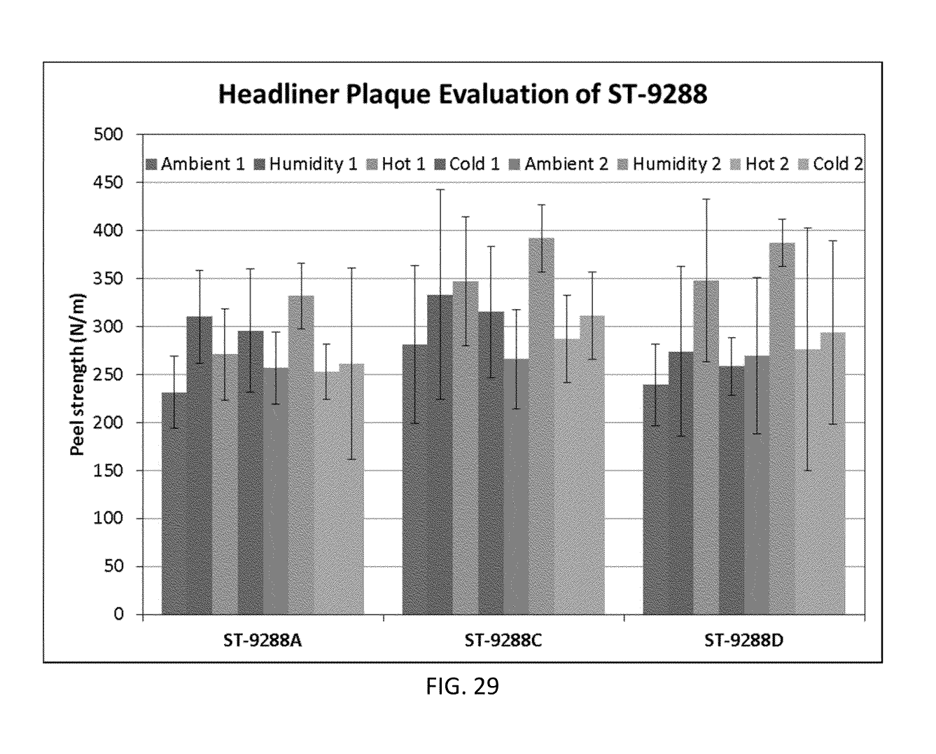

FIG. 29 shows the results of peel strength measurement on various headliner plaque constructs. FIG. 30 shows the test conditions used in Example 10. Cold refers to −30 degrees Celsius, hot refers to 85 degrees Celsius, and the different ambient bars represent different measurements at the ambient conditions. From left to right in each bar grouping, the bars represent, Ambient 1, Humidity 1, Hot 1, Cold 1, Ambient 2, Humidity 2, Hot 2 and Cold 2 with the ambient and humidity conditions noted in the above examples.

As shown in FIG. 29, the headliner plaque peel strength increases when the high viscosity tie layer is present. The addition of more PP (50 gsm PP in ST-9288D vs 40 gsm PP in 9288C) did not substantially alter the peel strength of the headliner plaques except under high humidity conditions. These results are consistent with the high viscosity tie layer increasing the peel strength. In particular, when the ST-9288A construct is compared to the ST-9288D construct (the only difference being the lack of a high viscosity tie layer in the ST-9288A construct), the peel strength on average increases.

### Example 11

Certain other films were tested for performance in this example and Examples 12-14. In these examples, the following abbreviations are used:

TABLE 3

| Film | |
|---|---|
| Abbreviation | Film |
| X1 | Xiro 45.311 60 gsm - Conventional film. |
| X2 | Xiro 45.311 80 gsm - Conventional film |
| A1 | A22.2227 60 gsm - high viscosity tie layer film |
| C1 | A22.2282C 60 gsm. Xiro 45.311 type CoPA |
| | adhesive and with high viscosity tie layer |
| C2 | A22.2282C 70 gsm -high viscosity tie layer |
| C3 | A22.2282C 80 gsm - high viscosity tie layer |

Several properties of the film are listed in the table below. Two types of adhesive components have been used and two film structures are involved. All of the evaluated films could be considered at least bi-layer films (with many of the films including 3-5 layers), which have one layer of polypropylene (PP) and one layer of adhesive. Polyamide copolymer (Co-PA) is used in all adhesive layers, but different types of CoPA components have been used. In addition, the areal density of each kind of film could be varied as well.

TABLE 4
Films evaluated for adhesion

| | | | | Co-Pa | PP |
|---|---|---|---|---|---|
| | | | Areal | Areal | Areal |
| | Co-PA | Film | Density | Density | Density |
| Film | Type | Structure | (g/m²) | (g/m²) | (g/m²) |
| X1 | Type1 | Regular | 60 | 30 | 30 |
| X2 | Type1 | Regular | 80 | 30 | 50 |
| A1 | Type2 | Enhanced | 60 | 30 | 30 |
| C1 | Type1 | Enhanced | 60 | 30 | 30 |
| C2 | Type1 | Enhanced | 70 | 30 | 40 |
| C3 | Type1 | Enhanced | 80 | 30 | 50 |

The Differential Scanning calorimeter (DSC) measurements were conducted using Mettler Toledo 822e equipment. The purpose of the DSC measurements was to differentiate film composition as well as confirm the adhesive component activating temperature. The test cycle was set as a two heating-cooling cycle procedure: 1) Ramp the temperature from 30 degrees C. to 200 degrees C. at the rate of 10 degrees C./min; 2) Cool down the temperature from 200 degrees C. to 30 degrees C.; 3) Repeat Step 1) and 4) Repeat Step 2). The analysis is mainly focused on Step 3), which is believed to have the best reflection of the chemical composition rather than thermal history.

The areal density was determined by measuring the weight of a disc with a 99 mm diameter. The areal density measurement was conducted on film samples to confirm the information received from the supplier. Areal densities were also measured on LWRT sheets with the evaluated films laminated on them and therefore the similarity is ensured among the tested LWRT substrates. The areal density was only measured on the whole film without further investigation on the areal density of each functional layer and the corresponding values of the adhesive layers were supplied by film manufacturer.

Requirements in peel adhesion are generally set for applications such as headliners. The adhesion performance is one important characteristic that is used to examine a film. The decorative fabric was applied to LWRT substrate by a thermal forming process. The LWRT substrate is heated in an oven, e.g., an IR oven, to a temperature above the melting point of the polyolefin resin used in LWRT and the fabric is compressed to the substrate when the LWRT sheet comes out of the oven but still remains at a temperature above the activation temperature of the adhesive component and probably also above the melting point of thermoplastic component. The whole assembly is expected to be at a temperature lower than the activation temperature of the adhesive component after the whole process. Specimens for peel tests were cut from flat panels with a uniform substrate thickness. The peel tests typically follow ASTM D903 standard (dated 2010) with potential minimal modifications, such as specimen dimensions and others.

In addition to headliners, a screening study was also conducted sometimes, where a lab molded flat panel of LWRT board and foam-type decorative fabric assembly was used instead of a part cut from a molded headliner. The reported data is based on the average of a minimum of five tested specimens. The adhesion performance was evaluated both under ambient condition as well as after specific environmental aging cycles.

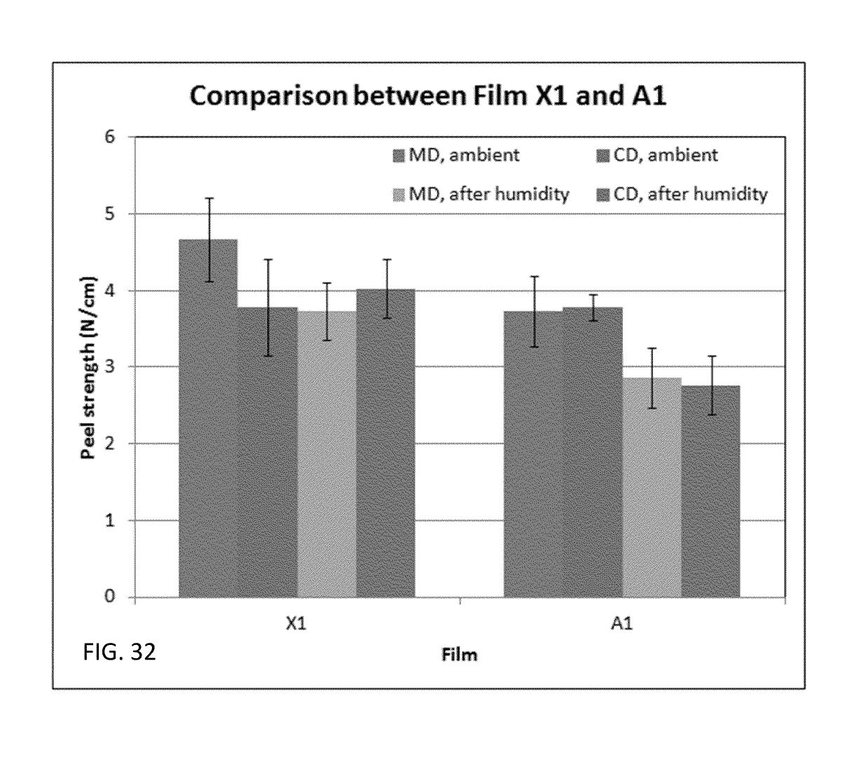

To have a fair comparison among films, Film X1 and X2 were picked as standard samples and were used as the control samples for all comparisons. The peel adhesion would also be affected by the substrate grades and the molding thickness of the selected substrate. Therefore, to minimize the test variation, the compared specimens included LWRT substrates from same production lot and molded to the same substrate thickness. The specimens tested under different environmental cycles were also collected from the same preparation process using the LWRT substrates in the same production run. FIG. 32 shows the comparison between Film X1 and A1 and the peel strength data, in both machine direction (MD) and cross machine direction (CD), is presented. Each bar grouping represents from left to right MD ambient, CD ambient, MD after humidity and CD after humidity. The measurements were performed on screening specimens prepared by a lab molding procedure. A piece of adhesive film was sandwiched by an LWRT substrate and foam-type fabric. The substrate was molded to 3.5 mm. The Film X1 shows slightly better performance than Film A1 under ambient conditions. However, Film A1 shows a performance drop after the humidity environmental cycle (35 degrees C., 95% humidity, 16 hours), while Film X1 could maintain at the same level of performance after this cycle. The performance change after environmental aging is a significant difference between Film X1 and Film A1. For example, Film X1 can still provide suitable adhesion performance at the same level after environmental aging. The performance difference between Film X1 and Film A1 is consistent with the different copolyamide material film, e.g., a copolyamide film lacking any caprolactam, providing enhanced performance.

### Example 12

The areal densities of tested films are listed in Table 5. The results confirm the specification information received from the film supplier. Table 6 summarizes the peaks observed in the second heating cycle (Step 3) of the DSC measurements. The endothermic peak around 110° C. is the melting peak of the adhesive component, while the higher temperature ones are associated with the polyolefin components. The exothermic peak around 55° C. is only noticed on films with Type 1 adhesive, which is the re-crystallization peak of the adhesive. The DSC measurement is used to confirm the difference among tested films.

TABLE 5
Areal density measurements on evaluated films

| | Areal |
|---|---|
| | Density |
| Film | (g/m²) |
| X1 | 60.5 |
| X2 | 77.4 |
| A1 | 59.8 |
| C1 | 59.9 |
| C2 | 71.2 |
| C3 | 79.2 |

TABLE 6
Peaks observed in second heating cycle of the DSC measurements

| | Peaks Associated with Co-PA | | Peaks Associated with PP | |
|---|---|---|---|---|
| | (° C.) | | (° C.) | |
| Film | Exothermic | Endothermic | Endothermic | Endothermic |
| X1 | 54.3 | 105.8 | 127.5 | 144.9 |
| X2 | 54.4 | 106.3 | 128.2 | 144.3 |
| A1 | None | 120.6 | 143.6 | 163.7 |
| C1 | 55.3 | 105.9 | 127.2 | 164.9 |
| C2 | 54.6 | 106.9 | 136.3 | 165.0 |
| C3 | 54.6 | 107.1 | 136.1 | 165.9 |

### Example 13

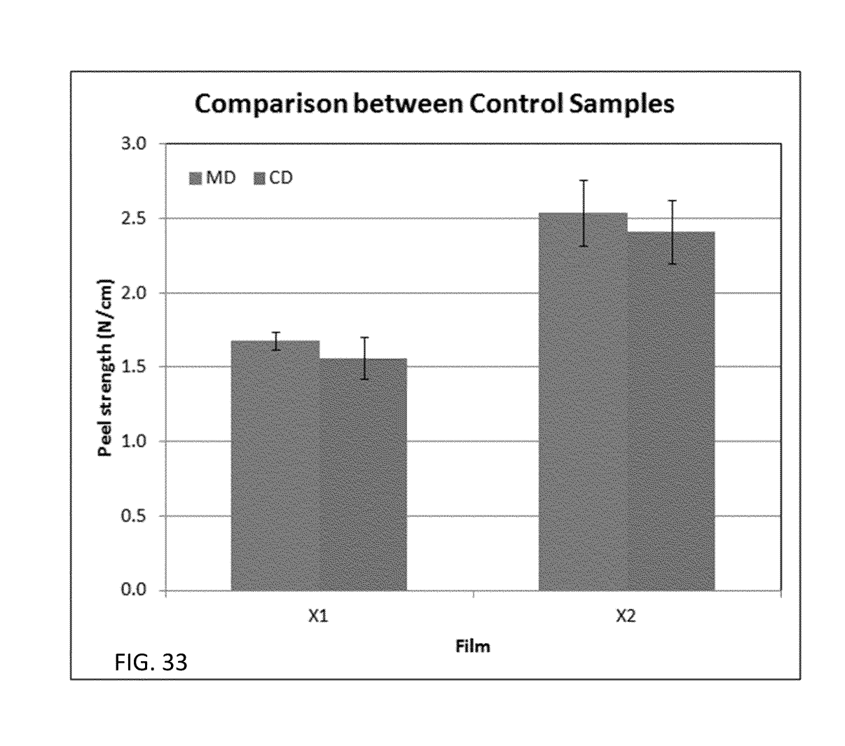

FIG. 33 shows the comparison between the two control samples under ambient condition, Film X1 and Film X2. Film X1 and Film X2 belong to the same product family and share the same material compositions. To amplify the difference between Film X1 and Film X2, the LWRT core substrate used in this particular test was molded to 6 mm, a thicker substrate thickness than typical applications. This represents a more challenging situation to achieve adhesion. The tested specimens were also prepared by the screening lab molding procedure. It is noticed that Film X2 shows significantly better peel strength than Film X1, even though the two films share the same type of adhesive component and also same amount of adhesive component. The performance difference is attributed to the porous nature of LWRT. During molding, the adhesive film was at the molten stage and the porous nature of LWRT makes it possible for the film to soak into the substrate. The additional high melting point polyolefin present in Film X2 and absent in Film X1 helps to maintain more adhesive component at the interface for adhesion.

### Example 14

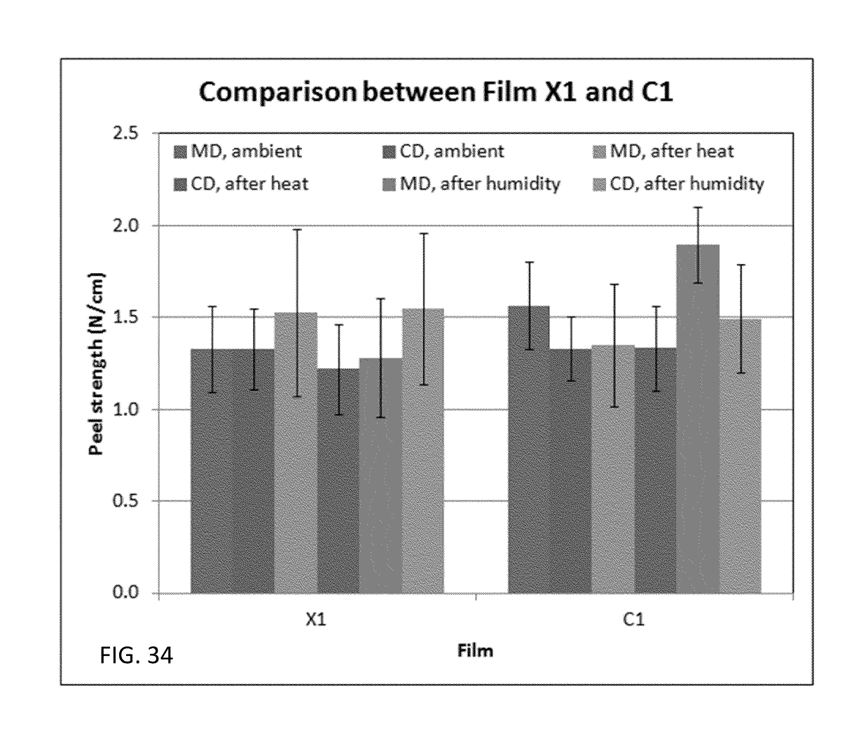

A film construction change was made, and a high viscosity tie layer was introduced. Instead of using additional polyolefin component to prevent the soaking of adhesive at the interface, this new construct may assist in prevention or slowing of the soaking of polyolefin, which may keep more adhesive at the interface. FIG. 34 shows the comparison between Film X1 and Film C1, which comprises the high viscosity tie layer. From left to right in each bar grouping, the bars represent MD ambient, CD ambient, MD after heat, CD after heat, MD after humidity and CD after humidity. The tested specimens in this comparison were cut from the molded headliners received from a headliner molder, and the substrate thickness is around 5 mm. The peel adhesion tests were conducted 1) under ambient condition, 2) after 24 hour heat aging at 90 degrees C., and 3) after 24 hour humidity aging at 50 degrees C. with 90% humidity. Film C1 shows generally comparable performance to Film X1, with some minor improvement.

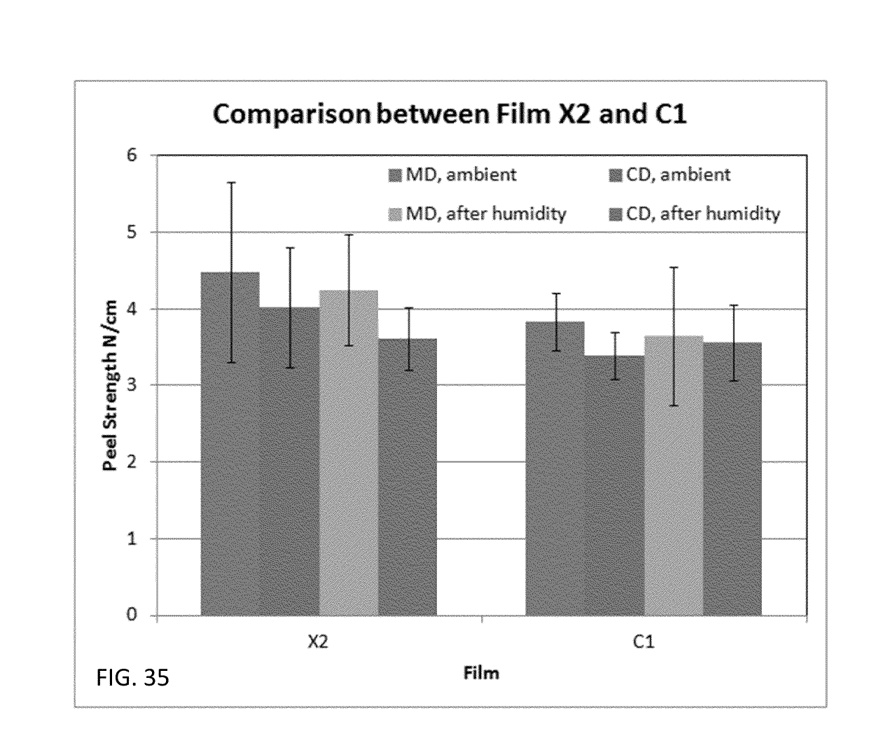

FIG. 35 shows the results from a comparison study between Film X2 and Film C1 (ambient and 16 hours of 35 degrees C. 90% humidity aging). From left to right in each bar grouping, the bars represent MD ambient, CD ambient, MD after humidity and CD after humidity. The tested specimens in this study were cut from headliners molded internally and the substrates were molded to about 3.5 mm. Film X2 has more promising performance than Film C1, which indicates the extra 20 g/m² of polypropylene was more efficient to improve the adhesion than the film structure change from regular structure to the enhanced one.

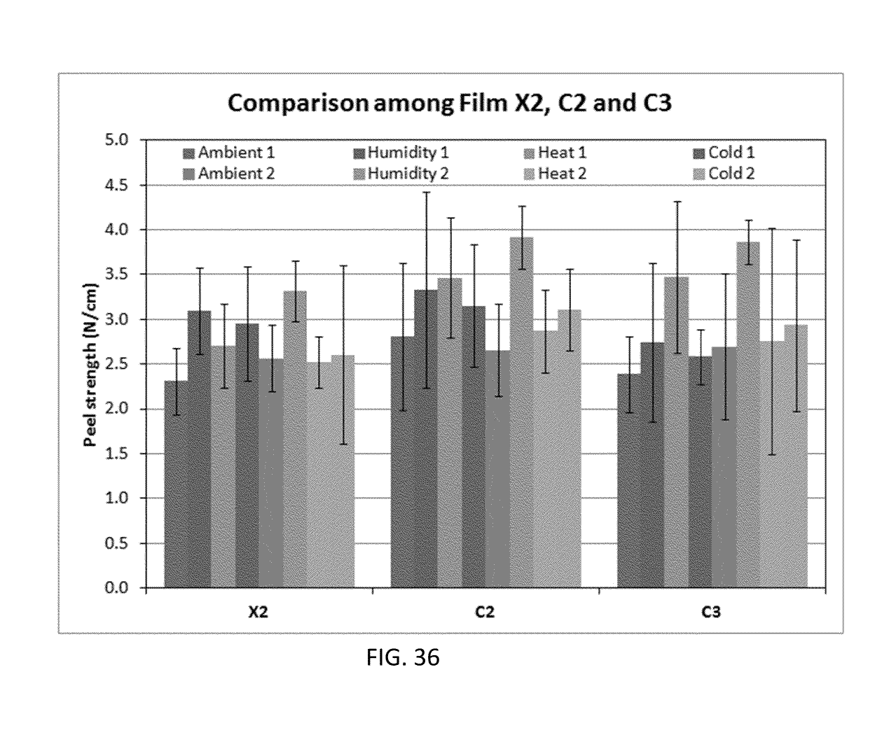

FIG. 36 shows the case to achieve the performance of Film X2 by the enhanced film structure at a lower areal density. All the specimens were cut from headliners molded internally. The tests were done 1) under ambient condition, 2) after humidity aging, 3) after heat aging, 4) after cold aging humidity and repeating conditions of 1) through 4). From left to right, the bar groupings represent ambient 1, humidity 1, heat 1, cold 1, ambient 2, humidity 2, heat 2, and cold 2. All three tested films, Film X2, Film C2 and Film C3, could survive the environmental cycles without a major performance drop. In this particular study, both Film C2 and C3 show improvements over Film X1, particularly after heating and humidity cycles. More importantly, Film C2 has a lighter areal density than Film X1. Therefore, Film C2, which has an areal density of 70 g/m², could be a potential performance improvement and also cost saving candidate for the applications utilizing Film X2. This result is believed to be due to the benefit of the high viscosity tie layer used in the enhanced type film structure.

The results of Examples 11-14, show that a better film chemistry helps the adhesion at the interface. The performance after environmental aging is associated with the type of adhesive used in the film. Additional non-adhesive components in the film also help the adhesion at the interface. The presence of extra polypropylene assists in prevention of loss of the adhesive component at the interface. This can improve the actual contact between adhesive and foam, which can subsequently improve the adhesion at the interface. Instead of increasing the amount of polypropylene, a high viscosity tie layer can also keep the adhesive component at the interface. The adhesive film selection is determined by the nature of two adherent components. A higher porosity generally requires more adhesive remain at the interface.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A composite material comprising:
a permeable core layer comprising a thermoplastic material and a plurality of reinforcing fibers;
a film disposed on the core layer, the film comprising a thermoplastic layer and a tie layer, in which a viscosity of thermoplastic material in the thermoplastic layer is greater than a viscosity of materials of the tie layer; and
a cover layer disposed on the film, in which the tie layer of the film is effective to increase adhesion between the cover layer and the film compared to a film lacking the tie layer.

2. The composite material of claim 1, in which the thermoplastic layer comprises a polyolefin material.

3. The composite material of claim 2, in which the thermoplastic layer comprises a first layer and a second layer.

4. The composite material of claim 3, in which at least one of the first layer and the second layer comprises a polypropylene.

5. The composite material of claim 4, in which the first layer comprises a first polypropylene comprising a first melt flow index and the second layer comprises a second polypropylene comprising a second melt flow index, in which the first melt flow index is lower than the second melt flow index.

6. The composite material of claim 5, in which the tie layer is present between the first layer and the second layer.

7. The composite material of claim 5, in which the film comprises a basis weight of less than 80 gsm, less than 70 gsm or less than 60 gsm.

8. The composite material of claim 1, in which the film comprises at five layers with one of the five layers comprising a polyamide or copolyamide optionally without any caprolactam.

9. The composite material of claim 7, in which the film comprises a first layer comprising a polypropylene, a second layer disposed on the first layer, the second layer comprising the tie layer, a third layer disposed on the second layer and comprising a polypropylene, a fourth layer disposed on the third layer and comprising an additional tie layer, and a fifth layer disposed on the fourth layer and comprising the polyamide or copolyamide optionally without any caprolactam.

10. The composite material of claim 9, in which the film comprises a basis weight of less than 80 gsm, less than 70 gsm or less than 60 gsm.

11. The composite material of claim 9, in which each of the five layers is present at about the same thickness.

12. The composite material of claim 9, in which the polypropylene of the third layer comprises a viscosity greater than a viscosity of polypropylene of the first layer.

13. The composite material of claim 12, in which a viscosity of the polypropylene of the third layer is about 50% higher than a viscosity of polypropylene in the first layer.

14. The composite material of claim 9, in which the tie layer and the additional tie layer comprise at least one common material.

15. The composite material of claim 1, in which the film comprises a bilayer comprising a first layer effective to provide adherence and a second non-polar layer coupled to the first layer.

16. The composite material of claim 1, in which the cover layer comprises one or more of a polyurethane, a non-woven material, a woven material, a fabric and a film.

17. The composite material of claim 1, further comprising an additional layer disposed between the film and the cover layer.

18. The composite material of claim 1, in which the core layer comprises polypropylene and glass fibers.

19. The composite material of claim 1, in which the thermoplastic material is present at about 20 weight percent to about 80 weight percent based on the weight of the core layer.

20. The composite material of claim 19, in which the glass fibers are present at about 30 weight percent to about 70 weight percent based on the weight of the core layer.

21-120. (canceled)
